(19) United States
(12) Patent Application Publication
(10) Pub. No.: US 2011/0016899 A1
(43) Pub. Date: Jan. 27, 2011

(54) TEMPERATURE CONTROL APPARATUS FOR IN-VEHICLE ELECTRIC STORAGE DEVICE

(75) Inventor: Takashi Ogura, Toyota-shi (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Toyota-Shi (JP)

(21) Appl. No.: 12/840,388

(22) Filed: Jul. 21, 2010

(30) Foreign Application Priority Data
Jul. 21, 2009 (JP) JP 2009-170364

(51) Int. Cl. B60H 1/32

(52) U.S. Cl. 62/239

(57) ABSTRACT

A temperature control apparatus for an in-vehicle electric storage device supplies air from a vehicle compartment to a secondary battery based on the temperature of the secondary battery. The fan air volume, which is the volume of air that is supplied from the vehicle compartment to the secondary battery, is set based on the degree of introduction of external air into the vehicle compartment.

### INCORPORATION BY REFERENCE

The disclosure of Japanese Patent Application No. 2009-170364 filed on Jul. 21, 2009 including the specification, drawings and abstract is incorporated herein by reference in its entirety.

### BACKGROUND OF THE INVENTION

1. Field of the Invention

The invention relates to a temperature control apparatus for an in-vehicle electric storage device, which supplies the air from a vehicle compartment to the in-vehicle electric storage device based on the temperature of the in-vehicle electric storage device.

2. Description of the Related Art

Japanese Patent Application Publication No. 2008-98060 (JP-A-2008-98060) describes a temperature control apparatus. A hybrid vehicle is provided with a secondary battery, which serves as an electric power supply that supplies electric power used to drive the vehicle. When the temperature of the secondary battery is low, the temperature control apparatus described in JP-A-2008-98060 increases the temperature of the secondary battery by supplying the air in the vehicle compartment, which has been warmed by an air-conditioner, to the secondary battery.

When the humidity in the vehicle compartment is high, the air supply to the secondary battery may cause condensation in the secondary battery. Therefore, only if it is estimated that the air supply to the secondary battery will not cause condensation based on an output from a humidity sensor that monitors the humidity in the vehicle compartment, the air supply to the secondary battery is permitted.

With the temperature control apparatus described in JP-A-2008-98060, it is possible to reduce the occurrence of condensation in the secondary battery. However, the humidity sensor is required. Therefore, it is not possible to apply the technology described in JP-A-2008-98060 to a vehicle that is not provided with a humidity sensor.

### SUMMARY OF THE INVENTION

The invention provides a temperature control apparatus for an in-vehicle electric storage device, which makes it possible both to increase the temperature of the in-vehicle electric storage device and to reduce the occurrence of condensation in the in-vehicle electric storage device even if a humidity sensor is not provided.

A first aspect of the invention relates to a temperature control apparatus for an in-vehicle electric storage device, which supplies air from a vehicle compartment to the in-vehicle electric storage device based on the temperature of the in-vehicle electric storage device. The temperature control apparatus includes: a controller that sets a supply air volume, which is a volume of air that is supplied from the vehicle compartment to the in-vehicle electric storage device, based on the degree of introduction of external air into the vehicle compartment; and an air blower that supplies the in-vehicle electric storage device with the air in the supply air volume that is set by the controller.

According to the first aspect, the volume of air that is supplied to the in-vehicle electric storage device is set based on the external air introduction degree that exerts a great influence on the humidity in the vehicle compartment. Therefore, it is possible both to reduce the occurrence of condensation in the in-vehicle electric storage device and to increase the temperature of the electric storage device even if a humidity sensor is not provided.

In the temperature control apparatus according to the first aspect, when the supply air volume that is used when an in-vehicle air-conditioner is in the external air introduction mode is a supply air volume A1 and the supply air volume that is used when the in-vehicle air-conditioner is in the internal air circulation mode is a supply air volume A2, the supply air volume A2 may be set to a value that is smaller than the supply air volume A1.

When the internal air circulation mode is selected, basically, ventilation is not provided in the vehicle compartment. Therefore, the humidity in the vehicle compartment is more likely to increase than when the external air introduction mode is selected. In light of this feature, the supply air volume A2 is set to a value that is smaller than the supply air volume A1. That is, the supply air volume that is used in the internal air circulation mode where it is estimated that the humidity in the vehicle compartment is high is set to a smaller value. Therefore, it is possible to more reliably reduce the occurrence of condensation in the in-vehicle electric storage device.

In the temperature control apparatus according to the first aspect, when the supply air volume that is used when it is determined that the vehicle window state is the open state is a supply air volume B1 and the supply air volume that is used when it is determined that the vehicle window state is the closed state is a supply air volume B2, the supply air volume B2 may be set to a value that is smaller than the supply air volume B1.

When the vehicle window state is the closed state, basically, ventilation is not provided in the vehicle compartment. Therefore, the humidity in the vehicle compartment is more likely to increase than when the vehicle window state is the open state. In light of this feature, the supply air volume B2 is set to a value that is smaller than the supply air volume B1. That is, the supply air volume that is used in the closed state where it is estimated that the humidity in the vehicle compartment is high is set to a smaller value. Therefore, it is possible to more reliably reduce the occurrence of condensation in the in-vehicle electric storage device.

In the temperature control apparatus according to the first aspect, when the supply air volume that is used when an in-vehicle air-conditioner is in the external air introduction mode and it is determined that the vehicle window state is the open state is a supply air volume C1 and the supply air volume that is used when the in-vehicle air-conditioner is in the external air introduction mode and it is determined that the vehicle window state is the closed state is a supply air volume C2, the supply air volume C2 may be set to a value that is smaller than the supply air volume C1.

When the external air introduction mode is selected and the vehicle window state is the closed state, the humidity in the vehicle compartment is more likely to increase than when the external air introduction mode is selected and the vehicle window state is the open state. In the light of this feature, the supply air volume C2 is set to a value smaller than the supply air volume C1. That is, the supply air volume that is used in the closed state where it is estimated that the humidity in the vehicle compartment is high is set to a smaller value. Therefore, it is possible to more reliably reduce the occurrence of condensation in the in-vehicle electric storage device.

In the temperature control apparatus according to the first aspect, when the supply air volume that is used when an in-vehicle air-conditioner is in the internal air circulation mode and it is determined that the vehicle window state is the open state is a supply air volume D1 and the supply air volume that is used when the in-vehicle air-conditioner is in the internal air circulation mode and it is determined that the vehicle window state is the closed state is a supply air volume D2, the supply air volume D2 may be set to a value that is smaller than the supply air volume D1.

When the internal air circulation mode is selected and the vehicle window state is the closed state, the humidity in the vehicle compartment is more likely to increase than when the internal air circulation mode is selected and the vehicle window state is the open state. In the light of this feature, the supply air volume D2 is set to a value smaller than the supply air volume D1. That is, the supply air volume that is used in the closed state where it is estimated that the humidity in the vehicle compartment is high is set to a smaller value. Therefore, it is possible to more reliably reduce the occurrence of condensation in the in-vehicle electric storage device.

In the temperature control apparatus according to the first aspect, when the supply air volume that is used when an in-vehicle air-conditioner is in the external air introduction mode and it is determined that the vehicle window state is the open state is a supply air volume C1, the supply air volume that is used when the in-vehicle air-conditioner is in the external air introduction mode and it is determined that the vehicle window state is the closed state is a supply air volume C2, the supply air volume that is used when the in-vehicle air-conditioner is in the internal air circulation mode and it is determined that the vehicle window state is the open state is a supply air volume D1, and the supply air volume that is used when the in-vehicle air-conditioner is in the internal air circulation mode and it is determined that the vehicle window state is the closed state is a supply air volume D2, the supply air volume D2 may be set to a value that is smaller than the supply air volume D1, the supply air volume D1 may be set to a value that is smaller than the supply air volume C2, and the supply air volume C2 may be set to a value that is smaller than the supply air volume C1.

When the internal air circulation mode is selected, the humidity in the vehicle compartment is more likely to increase than when the external air introduction mode is selected. Also, when the vehicle window state is the closed state, the humidity is more likely to increase than when the vehicle window state is the open state. In the light of this feature, the supply air volume C2 is set to a value that is smaller than the supply air volume C1, the supply air volume D1 is set to a value that is smaller than the supply air volume C2, and the supply air volume D2 is set to a value smaller than the supply air volume D1. Therefore, it is possible to more reliably reduce the occurrence of condensation in the in-vehicle electric storage device.

In the temperature control apparatus according to the first aspect, when the temperature of the in-vehicle electric storage device is lower than the normal temperature reference value, which is used to determine whether the charge-discharge performance of the in-vehicle electric storage device is maintained at a charge-discharge performance required to drive a vehicle, the controller may set the supply air volume based on the temperature of the in-vehicle electric storage device.

The likelihood that condensation will occur in the in-vehicle electric storage device is correlated with the temperature of the in-vehicle electric storage device. In the light of this feature, the supply air volume is set based on the temperature of the in-vehicle electric storage device. Therefore, it is possible to more reliably reduce the occurrence of condensation in the in-vehicle electric storage device.

In the thus configured temperature control apparatus, when the temperature of the in-vehicle electric storage device is lower than the normal temperature reference value, the controller may set the supply air volume to a smaller value as the temperature of the in-vehicle electric storage device decreases.

The likelihood that condensation will occur in the in-vehicle electric storage device tends to increases as the temperature of the in-vehicle electric storage device decreases. In the light of this feature, the supply air volume is set to a smaller value as the temperature of the in-vehicle electric storage device decreases. Therefore, it is possible to more reliably reduce the occurrence of condensation in the in-vehicle electric storage device.

In the temperature control apparatus according to the first aspect, when the temperature of the in-vehicle electric storage device is lower than the normal temperature reference value, which is used to determine whether the charge-discharge performance of the in-vehicle electric storage device is maintained at a charge-discharge performance required to drive a vehicle, the controller may set the supply air volume based on the difference between the temperature of the in-vehicle electric storage device and the temperature in the vehicle compartment.

The likelihood that condensation will occur in the in-vehicle electric storage device is correlated with the difference between the temperature of the in-vehicle electric storage device and the temperature in the vehicle compartment. In the light of this feature, the supply air volume is set based on the difference between the temperature of the in-vehicle electric storage device and the temperature in the vehicle compartment. Therefore, it is possible to more reliably reduce the occurrence of condensation in the in-vehicle electric storage device.

In the thus configured temperature control apparatus, when the temperature of the in-vehicle electric storage device is lower than the normal temperature reference value and the temperature in the vehicle compartment is higher than the temperature of the in-vehicle electric storage device, the controller may set the supply air volume to a smaller value as the difference between the temperature of the in-vehicle electric storage device and the temperature in the vehicle compartment increases.

The likelihood that condensation will occur in the in-vehicle electric storage device tends to increase as the above-described temperature difference increases. In the light of this feature, the supply air volume is set to a smaller value as the difference between the temperature of the in-vehicle electric storage device and the temperature in the vehicle compartment increases. Therefore, it is possible to more reliably reduce the occurrence of condensation in the in-vehicle electric storage device.

In the thus configured temperature control apparatus, when the temperature in the vehicle compartment is higher than the temperature of the in-vehicle electric storage device and the difference between the temperature of the in-vehicle electric storage device and the temperature in the vehicle compartment is larger than a reference temperature difference, the air blower may refrain from supplying the air from the vehicle compartment to the in-vehicle electric storage device.

When the temperature in the vehicle compartment is higher than the temperature of the in-vehicle electric storage device and the difference between the temperature of the in-vehicle electric storage device and the temperature in the vehicle compartment is larger than the reference temperature difference, there is a possibility that condensation will occur in the in-vehicle electric storage device because the temperature of the in-vehicle electric storage device is excessively lower than the temperature in the vehicle compartment. In the light of this feature, the air is not supplied from the vehicle compartment to the in-vehicle electric storage device. Therefore, it is possible to more reliably reduce the occurrence of condensation in the in-vehicle electric storage device.

In the temperature control apparatus according to the first aspect, when the temperature of the in-vehicle electric storage device is equal to or higher than the normal temperature reference value, which is used to determine whether the charge-discharge performance of the in-vehicle electric storage device is maintained at a charge-discharge performance required to drive a vehicle, the air blower may refrain from supplying the air from the vehicle compartment to the in-vehicle electric storage device.

When the temperature of the in-vehicle electric storage device is equal to or higher than the normal temperature reference value, that is, when there is no possibility that the charge-discharge performance will deteriorate due to the low temperature of the in-vehicle electric storage device, the air is not supplied to the in-vehicle electric storage device. Therefore, it is possible to suppress waste of energy due to unnecessary air supply.

In the thus configured temperature control apparatus, when the temperature of the in-vehicle electric storage device is equal to or higher than the high temperature reference value that is higher than the normal temperature reference value, the air blower may supply the air from the vehicle compartment to the in-vehicle electric device.

When the temperature of the in-vehicle electric storage device is equal to or higher than the high temperature reference value, that is, when there is a possibility that the charge-discharge performance of the in-vehicle electric storage device will deteriorate because the temperature of the in-vehicle electric storage device is high, the air is supplied to the in-vehicle electric storage device to decrease the temperature of the in-vehicle electric storage device. Therefore, it is possible to suppress deterioration of the charge-discharge performance.

In the thus configured temperature control apparatus, when the temperature of the in-vehicle electric storage device is lower than the extremely-low temperature reference value that is lower than the normal temperature reference value, which is used to determine whether the charge-discharge performance of the in-vehicle electric storage device is maintained at a charge-discharge performance required to drive a vehicle, the air blower may refrain from supplying the air from the vehicle compartment to the in-vehicle electric storage device.

It is confirmed that when the temperature of the in-vehicle electric storage device is lower than the extremely-low temperature reference value, condensation is likely to occur in the in-vehicle electric storage device due to the air supply to the in-vehicle electric storage device. In the light of this feature, when the temperature of the in-vehicle electric storage device is lower than the extremely-low temperature reference value, the air is not supplied from the vehicle compartment to the in-vehicle electric storage device. Therefore, it is possible to more reliably reduce the occurrence of condensation in the in-vehicle electric storage device.

In the thus configured temperature control apparatus, wherein when the temperature of the in-vehicle electric storage device is lower than the low temperature reference value that is lower than the normal temperature reference value and higher than the extremely-low temperature reference value and an in-vehicle air-conditioner is in the internal air circulation mode, the air blower may refrain from supplying the air from the vehicle compartment to the in-vehicle electric storage device.

When the temperature of the in-vehicle electric storage device is higher than the extremely-low temperature reference value, although there is basically a low possibility that condensation will occur due to the air supply to the in-vehicle electric storage device, the likelihood that condensation will occur increases as the temperature of the in-vehicle electric storage device approaches the extremely-low temperature reference value. Therefore, in such a temperature state, if the air having a high humidity is supplied from the vehicle compartment to the in-vehicle electric storage device, the likelihood that condensation will occur is relatively high even if the temperature of the in-vehicle electric storage device is higher than the extremely-low temperature reference value. In the light of this feature, when the temperature of the in-vehicle electric storage device is lower than the low temperature reference value that is lower than the normal temperature reference value and higher than the extremely-low temperature reference value and the internal air circulation mode is selected, the air is not supplied from the vehicle compartment to the in-vehicle electric storage device. Therefore, it is possible to more reliably reduce the occurrence of condensation in the in-vehicle electric storage device.

In the thus configured temperature control apparatus, when the temperature of the in-vehicle electric storage device is lower than the low temperature reference value that is lower than the normal temperature reference value and higher than the extremely-low temperature reference value and it is determined that the vehicle window state is the closed state, the air blower may refrain from supplying the air from the vehicle compartment to the in-vehicle electric storage device.

When the temperature of the in-vehicle electric storage device is higher than the extremely-low temperature reference value, although there is basically a low possibility that condensation will occur due to the air supply to the in-vehicle electric storage device, the likelihood that condensation will occur increases as the temperature of the in-vehicle electric storage device approaches the extremely-low temperature reference value. Therefore, in such a temperature state, if the air having a high humidity is supplied from the vehicle compartment to the in-vehicle electric storage device, the likelihood that condensation will occur is relatively high even if the temperature of the in-vehicle electric storage device is higher than the extremely-low temperature reference value. In the light of this feature, when the temperature of the in-vehicle electric storage device is lower than the low temperature reference value that is lower than the normal temperature reference value and higher than the extremely-low temperature reference value and the vehicle window state is the closed state, the air is not supplied from the vehicle compartment to the in-vehicle electric storage device. Therefore, it is possible to more reliably reduce the occurrence of condensation in the in-vehicle electric storage device.

In the temperature control apparatus according to the first aspect, when an in-vehicle air-conditioner is in the internal air circulation mode, the air blower may refrain from supplying the air from the vehicle compartment to the in-vehicle electric storage device.

When the internal air circulation mode is selected, basically, ventilation is not provided in the vehicle compartment. Therefore, the humidity in the vehicle compartment is more likely to increase than when the external air introduction mode is selected. In the light of this feature, when the internal air circulation mode is selected, the air is not supplied from the vehicle compartment to the in-vehicle electric storage device. Therefore, it is possible to more reliably reduce the occurrence of condensation in the in-vehicle electric storage device.

In the thus configured temperature control apparatus, when the in-vehicle air-conditioner is in the internal air circulation mode and it is determined that the vehicle window state is the open state, the air blower may supply the air from the vehicle compartment to the in-vehicle electric storage device.

Even when the internal air circulation mode is selected, if the vehicle window state is the open state, the possibility that the air supply from the vehicle compartment to the in-vehicle electric storage device will cause condensation in the in-vehicle electric storage device is sufficiently low. In the light of this feature, when the in-vehicle air-conditioner is in the internal air circulation mode and the vehicle window state is the open state, the air is supplied from the vehicle compartment to the in-vehicle electric storage device. Therefore, it is possible to promptly increase the temperature of the in-vehicle electric storage device that is in the low temperature state.

In the temperature control apparatus according to the first aspect, when it is determined that the vehicle window state is the closed state, the air blower may refrain from supplying the air from the vehicle compartment to the in-vehicle electric storage device.

When the vehicle window state is the closed state, basically, ventilation is not provided in the vehicle compartment. Therefore, the humidity in the vehicle compartment is more likely to increase than when the vehicle window state is the open state. In the light of this feature, when the vehicle window state is the closed state, the air is not supplied from the vehicle compartment to the in-vehicle electric storage device. Therefore, it is possible to more reliably reduce the occurrence of condensation in the in-vehicle electric storage device.

In the thus configured temperature control apparatus, when it is determined that the vehicle window state is the closed state and an in-vehicle air-conditioner is in the external air introduction mode, the air blower may supply the air from the vehicle compartment to the in-vehicle electric storage device.

Even when the vehicle window state is the closed state, if the in-vehicle air-conditioner is in the external air introduction mode, the possibility that the air supply from the vehicle compartment to the in-vehicle electric storage device will cause condensation in the in-vehicle electric storage device is sufficiently low. In the light of this feature, when the in-vehicle air-conditioner is in the external air introduction mode and the vehicle window state is the closed state, the air is supplied from the vehicle compartment to the in-vehicle electric storage device. Therefore, it is possible to promptly increase the temperature of the in-vehicle electric storage device in the low temperature state.

A second aspect of the invention relates to a temperature control apparatus for an in-vehicle electric storage device, which supplies air from a vehicle compartment to the in-vehicle electric storage device based on a temperature of the in-vehicle electric storage device. The temperature control apparatus includes: a controller that sets a supply air volume, which is a volume of air that is supplied from the vehicle compartment to the in-vehicle electric storage device, to a smaller value as the temperature of the in-vehicle electric storage device decreases, when the temperature of the in-vehicle electric storage device is lower than the normal temperature reference value, which is used to determine whether the charge-discharge performance of the in-vehicle electric storage device is maintained at a charge-discharge performance required to drive a vehicle; and an air blower that supplies the in-vehicle electric storage device with the air in the supply air volume that is set by the controller.

A third aspect of the invention relates to a temperature control apparatus for an in-vehicle electric storage device, which supplies air from a vehicle compartment to the in-vehicle electric storage device based on a temperature of the in-vehicle electric storage device. The temperature control apparatus includes: a controller that sets a supply air volume, which is a volume of air that is supplied from the vehicle compartment to the in-vehicle electric storage device, to a smaller value as a difference between the temperature of the in-vehicle electric storage device and a temperature in the vehicle compartment increases, when the difference is smaller than a reference temperature difference, which is used to determine whether there is a high possibility that an air supply from the vehicle compartment to the in-vehicle electric storage device causes condensation in the in-vehicle electric storage device; and an air blower that supplies the in-vehicle electric storage device with the air in the supply air volume that is set by the controller.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a view schematically showing the structure of a vehicle that includes a temperature control apparatus for an in-vehicle electric storage device according to a first embodiment of the invention;

FIG. 2 is a flowchart showing steps of the basic temperature control process that is executed by an electronic control unit according to the first embodiment;

FIG. 3 is a flowchart showing steps of the temperature increase air volume control process that is executed by the electronic control unit according to the first embodiment;

FIGS. 4A to 4D illustrate a timing chart showing an example of the manner for executing the temperature increase air volume control process according to the first embodiment;

FIG. 5 is a flowchart showing steps of the temperature increase air volume control process that is executed by the electronic control unit of the temperature control apparatus for an in-vehicle electric storage device according to a second embodiment of the invention;

FIGS. 6A to 6D illustrate a timing chart showing an example of the manner for executing the temperature increase air volume control process according to the second embodiment;

FIG. 7 is a flowchart showing steps of the temperature increase air volume control process that is executed by the electronic control unit of the temperature control apparatus for an in-vehicle electric storage device according to a third embodiment of the invention;

FIGS. 8A to 8E illustrate a timing chart showing an example of the manner for executing the temperature increase air volume control process according to the third embodiment;

FIG. 9 is a flowchart showing steps of the temperature increase air volume control process that is executed by the electronic control unit of the temperature control apparatus for an in-vehicle electric storage device according to a fourth embodiment of the invention;

FIGS. 10A to 10E illustrate a timing chart showing an example of the manner for executing the temperature increase air volume control process according to the fourth embodiment;

FIG. 11 is a flowchart showing steps of the temperature increase air volume control process that is executed by the electronic control unit of the temperature control apparatus for an in-vehicle electric storage device according to a fifth embodiment of the invention;

FIGS. 12A to 12E illustrate a timing chart showing an example of the manner for executing the temperature increase air volume control process according to the fifth embodiment;

FIG. 13 is a flowchart showing steps of the temperature increase air volume control process that is executed by the electronic control unit of the temperature control apparatus for an in-vehicle electric storage device according to a sixth embodiment of the invention;

FIGS. 14A to 14E illustrate a timing chart showing an example of the manner for executing the temperature increase air volume control process according to the sixth embodiment;

FIG. 15 is a flowchart showing steps of the temperature increase air volume control process that is executed by the electronic control unit of the temperature control apparatus for an in-vehicle electric storage device according to a seventh embodiment of the invention;

FIGS. 16A to 16E illustrate a timing chart showing an example of the manner for executing the temperature increase air volume control process according to the seventh embodiment;

FIG. 17 is a flowchart showing steps of the temperature increase air volume control process that is executed by the electronic control unit of the temperature control apparatus for an in-vehicle electric storage device according to an eighth embodiment of the invention;

FIG. 18 is a graph showing the relationship between the temperature of the in-vehicle electric storage device and the battery temperature control according to the invention;

FIG. 19 is a flowchart showing steps of the temperature increase air volume control process that is executed by the electronic control unit of the temperature control apparatus for an in-vehicle electric storage device according to a ninth embodiment of the invention;

FIG. 20 is a flowchart showing steps of the temperature increase air volume control process that is executed by the electronic control unit of the temperature control apparatus for an in-vehicle electric storage device according to a tenth embodiment of the invention;

FIG. 21 is a graph showing an example of the relationship between the temperature of a secondary battery and the volume of air supplied by a fan, the relationship being used by the temperature control apparatus for an in-vehicle electric storage device according to an eleventh embodiment of the invention; and

FIG. 22 is a graph showing an example of the relationship between the volume of air supplied by the fan and the difference between the temperature of the secondary battery and the temperature in a vehicle compartment, the relationship being used by the temperature control apparatus for an in-vehicle electric storage device according to a twelfth embodiment of the invention.

### DETAILED DESCRIPTION OF THE EXAMPLE EMBODIMENTS

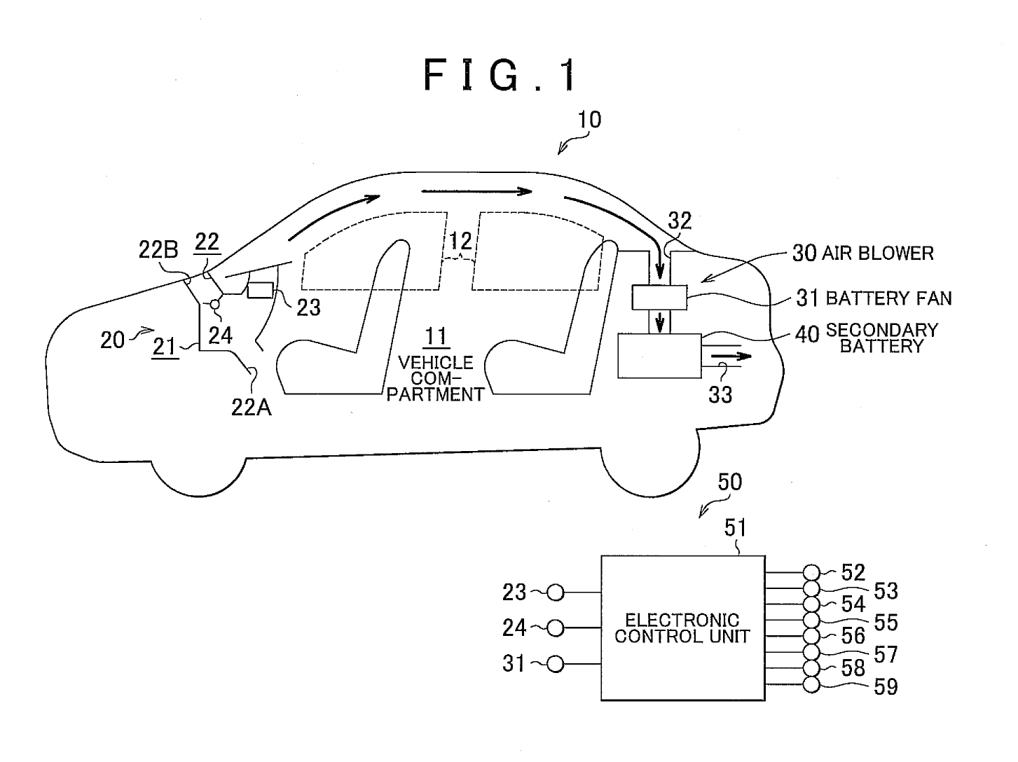

Hereafter, a temperature control apparatus for an electric storage device mounted in a hybrid vehicle according to a first embodiment of the invention will be described with reference to FIGS. 1 to 4.

A vehicle 10, shown in FIG. 1, in the first embodiment includes an air-conditioner 20 that adjusts the temperature in a vehicle compartment 11, a secondary battery 40 that serves as an electric power supply for the vehicle 10, an air blower 30 that supplies the air from the vehicle compartment 11 to the secondary battery 40, and a control apparatus 50 that comprehensively controls these devices.

The air-conditioner 20 includes an air-conditioning unit 21 that warms or cools the air in the vehicle compartment 11, an air duct 22 through which the air is supplied to the air-conditioning unit 21, and an air-conditioning fan 23 that supplies the air, of which the temperature has been adjusted by the air-conditioning unit 21, into the vehicle compartment 11.

The air-conditioning unit 21 may be operated in either the internal air circulation mode or the external air introduction mode. In the internal air circulation mode, the air in the vehicle compartment 11 (hereinafter, referred to as “internal air” where appropriate) is circulated within the vehicle compartment 11 to warm or cool the air in the vehicle compartment 11. In the external air introduction mode, the air outside the vehicle 10 (hereinafter, referred to as “external air” where appropriate) is introduced into the vehicle compartment 11 to warm or cool the air in the vehicle compartment 11.

The air duct 22 includes an internal air passage 22A that guides the internal air to the air-conditioning unit 21, and an external air passage 22B that guides the external air to the air-conditioning unit 21. An internal air/external air switching door 24 that regulates the airflow within the air duct 22 is provided at a portion where the internal air passage 22A and the external air passage 22B meet.

The internal air/external air switching door 24 may be in any one of the internal air circulation position, the external air introduction position and the intermediate opening position. When being in the internal air circulation position, the internal air/external air switching door 24 permits the airflow through the internal air passage 22A and blocks the airflow through the external passage 22B. When being in the external air introduction position, the internal air/external air switching door 24 blocks the airflow through the internal air passage 22A and permits the airflow through the external air passage 22B. When being in the intermediate opening position, the internal air/external air switching door 24 permits both the airflow through the internal air passage 22A and the airflow through the external passage 22B.

The air blower 30 includes a battery fan 31, an intake passage 32, and a discharge passage 33. The battery fan 31 supplies the air to the secondary battery 40. The intake passage 32 provides communication between the vehicle compartment 11 and an air inlet of the secondary battery 40. The discharge passage 33 provides communication between an air outlet of the secondary battery 40 and the outside of the vehicle compartment 11. The air is supplied from the vehicle compartment 11 to the secondary battery 40 through the intake passage 32 while the battery fan 31 rotates. The air that has passed through the secondary battery 40 is discharged to the outside of the vehicle compartment 11 through the discharge passage 33.

The control apparatus 50 includes various sensors and switches, and an electronic control unit 51. The various sensors include a vehicle compartment temperature sensor 52, a secondary battery temperature sensor 53, and a pulse sensor 54. The various switches include an air volume setting switch 55, an internal air mode/external air mode selection switch 56, an air-conditioning switch 57, a temperature setting switch 58, and a door window switch 59. The electronic control unit 51 executes controls over the various devices in the vehicle based on the signal from these sensors and switches. A temperature control apparatus for an in-vehicle electric storage device according to the first embodiment is formed of the air blower 30 and the control apparatus 50.

The vehicle compartment temperature sensor 52 is provided in the vehicle compartment 11, and outputs a signal corresponding to the temperature of the air in the vehicle compartment 11 (hereinafter, referred to as “vehicle compartment temperature TA”). The secondary battery temperature sensor 53 is provided at the secondary battery 40, and outputs a signal corresponding to the temperature of the secondary battery 40 (hereinafter, referred to as “secondary battery temperature TB”). The pulse sensor 54 is provided at a door of the vehicle 10, and outputs a signal corresponding to the open/close positions of a door window 12. The air volume setting switch 55 is provided in a control panel of the air-conditioning unit 21, and moved within the position range from the minimum air volume position to the maximum air volume position by a driver. The internal air mode/external air mode selection switch 56 is provided in the control panel of the air-conditioning unit 21, and is placed in either the internal air circulation position or the external air introduction position by the driver. The air-conditioning switch 57 is provided in the control panel of the air-conditioning unit 21, and is placed in either the off position or the on position by the driver. The temperature setting switch 58 is provided in the control panel of the air-conditioning unit 21, and is moved within the position range from the lowest temperature position to the highest temperature position by the driver. The door window switch 59 is provided at the door of the vehicle 10, and is moved within the position range from the fully-open position, in which the door window 12 is fully open, to the fully-closed position, in which the door window 12 is fully closed.

Example of the controls executed by the electronic control unit 51 include the air-conditioning control for adjusting the temperature in the vehicle compartment 11 through the control over the air-conditioner 20 and the battery temperature control for adjusting the secondary battery temperature TB through the control over the battery fan 31.

In the air-conditioning control, the target value for the vehicle compartment temperature TA is set based on the operation states of the air volume setting switch 55 and the temperature setting switch 58, and the operation of the air-conditioner 20 is controlled based on the difference between the sensor value and the target value.

The battery temperature control includes the battery temperature decrease control that is executed when the temperature of the secondary battery 40 is high, and the battery temperature increase control that is executed when the temperature of the secondary battery 40 is low. In the battery temperature decrease control, the temperature of the secondary battery 40 is decreased and maintained within the appropriate temperature range. In the battery temperature increase control, the temperature of the secondary battery 40 is increased and maintained within the appropriate temperature range. The appropriate temperature range of the secondary battery temperature TB is the range equal to or higher than the normal temperature reference value TBL and lower than the high temperature reference value TBH (TBL≦TB<TBH).

In the battery temperature increase control, the battery air volume control (temperature increase air volume control) for increasing the temperature of the secondary battery 40 is executed when the secondary battery temperature TB is lower than the normal temperature reference value TBL and lower than the vehicle compartment temperature TA in order to adjust the volume of air that is supplied to the secondary battery 40 by the battery fan 31 (hereinafter, referred to as “fan air volume V”). In the battery temperature decrease control, the battery air volume control (temperature decrease air volume control) for decreasing the temperature of the secondary battery 40 is executed when the secondary battery temperature TB is equal to or higher than the high temperature reference value TBH and equal to or higher than the vehicle compartment temperature TA.

The normal temperature reference value TBL is a value that is used to determine whether the charge-discharge performance of the secondary battery 40 is maintained at the performance that is required to drive the vehicle 10. The normal temperature reference value TBL is derived through, for example, a test, and is stored in the electronic control unit 51. When the secondary battery temperature TB is lower than the normal temperature reference value TBL, it is estimated that the charge-discharge performance will not be maintained at the performance that is required to drive the vehicle 10 because the secondary battery temperature TB is low.

The high temperature reference value TBH is a value that is used to determine whether the charge-discharge performance of the secondary battery 40 is maintained at the performance that is required to drive the vehicle 10. The high temperature reference value TBH is derived through, for example, a test, and is stored in the electronic control unit 51. When the secondary battery temperature TB is equal to or higher than the high temperature reference value TBH, it is estimated that the charge-discharge performance will not be maintained at the performance that is required to drive the vehicle 10 because the secondary battery temperature TB is high.

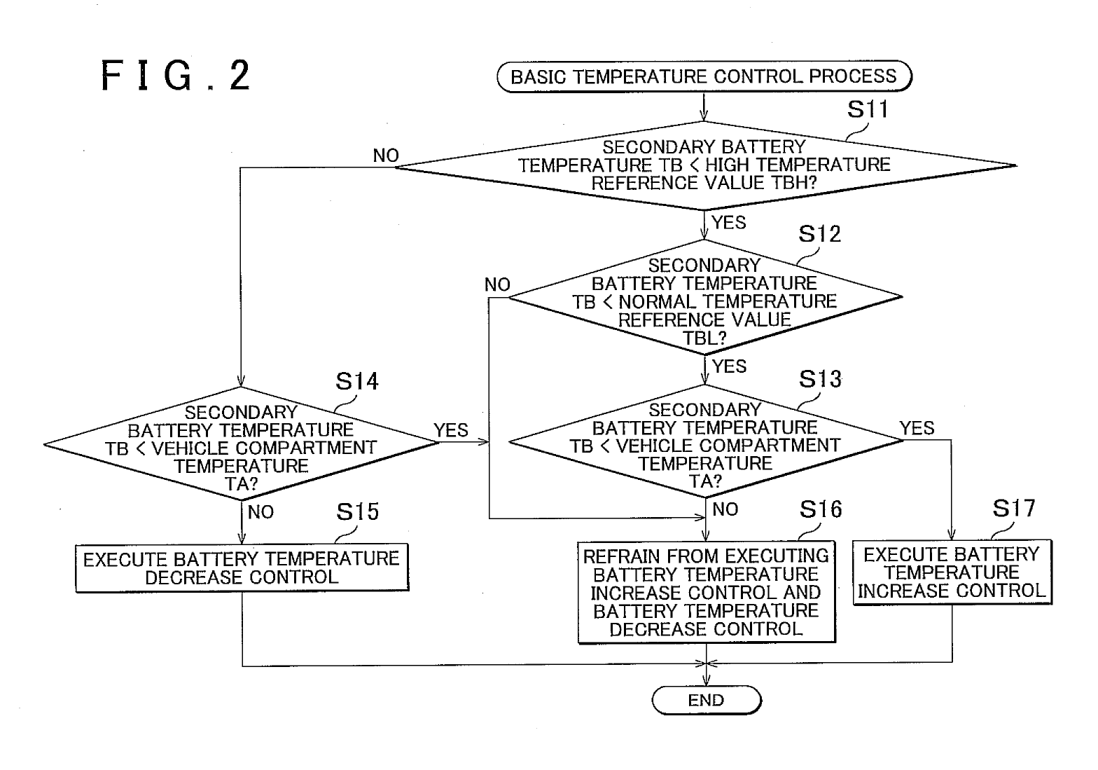

The basic temperature control process for the battery temperature control will be described in detail with reference to FIG. 2. The electronic control unit 51 periodically executes the process at predetermined calculation intervals during the operation of an internal combustion engine.

In the process, the following steps are executed to determine the secondary battery temperature TB. In step (hereinafter, referred to as “S”) 11, it is determined whether the secondary battery temperature TB is lower than the high temperature reference value TBH. In S12, it is determined whether the secondary battery temperature TB is lower than the normal temperature reference value TBL. In each of S13 and S14, it is determined whether the secondary battery temperature TB is lower than the vehicle compartment temperature TA. Based on these determination results, one of the following processes A) to E) is executed. Based on the results of determinations made in S11 to S13, it is determined whether the battery temperature increase air volume control is executed. Whether the temperature increase execution condition is satisfied is determined based on the results of determinations made in S11 to S13. When affirmative determinations are made in all of S11 to S13, the temperature increase execution condition is satisfied.

A) If it is determined that the secondary battery temperature TB is equal to or higher than the high temperature reference value TBH and it is determined that the secondary battery temperature TB is equal to or higher than the vehicle compartment temperature TA, the electronic control unit 51 starts or continues execution of the battery temperature decrease control in S15.

B) If it is determined that the secondary battery temperature TB is equal to or higher than the high temperature reference value TBH and it is determined that the secondary battery temperature TB is lower than the vehicle compartment temperature TA, the electronic control unit 51 refrains from executing the battery temperature increase control and the battery temperature decrease control in S16.

C) If it is determined that the secondary battery temperature TB is lower than the high temperature reference value TBH, it is determined that the secondary battery temperature TB is lower than the normal temperature reference value TBL, and it is determined that the secondary battery temperature TB is equal to or higher than the vehicle compartment temperature TA, the electronic control unit 51 refrains from executing the battery temperature increase control and the battery temperature decrease control in S16.

D) If it is determined that the secondary battery temperature TB is lower than the high temperature reference value TBH and it is determined that the secondary battery temperature TB is equal to or higher than the normal temperature reference value TBL, the electronic control unit 51 refrains from executing the battery temperature increase control and the battery temperature decrease control in S16.

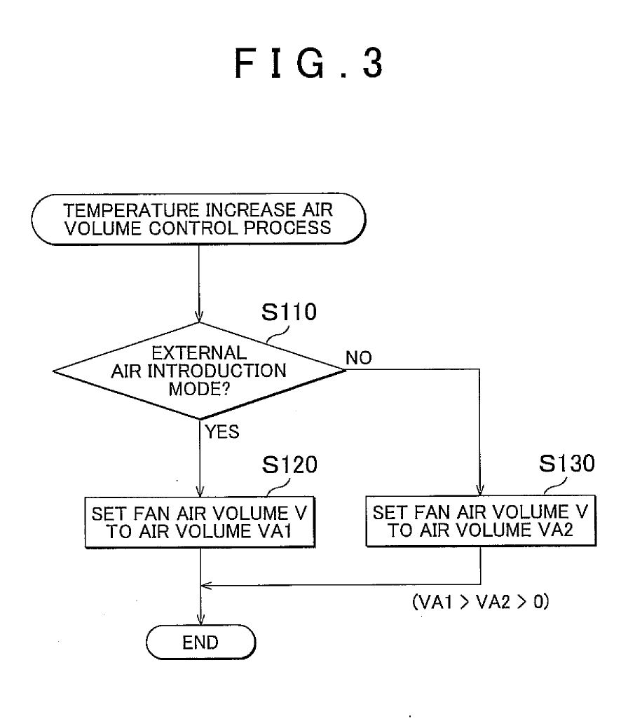

E) If it is determined that the secondary battery temperature TB is lower than the high temperature reference value TBH, it is determined that the secondary battery temperature TB is lower than the normal temperature reference value TBL, and it is determined that the secondary battery temperature TB is lower than the vehicle compartment temperature TA, the electronic control unit 51 starts or continues execution of the battery temperature increase control in S17. That is, the electronic control unit 51 starts or continues execution of the temperature increase air volume control process shown in FIG. 3.

The temperature increase air volume control process for the battery temperature increase control will be described with reference to FIG. 3. The electronic control unit 51 periodically executes the temperature increase air volume control process at predetermined calculation intervals during the operation of the internal combustion engine.

If it is determined in S110 that the external air introduction mode is selected as the air mode, the fan air volume V is set to the air volume VA1 in S120. That is, the rotational speed of the battery fan 31 is set to a rotational speed that corresponds to the air volume VA1.

If it is determined in S110 that the internal air circulation mode is selected as the air mode, the fan air volume V is set to the air volume VA2 that is smaller than the air volume VA1 and larger than 0. That is, the rotational speed of the battery fan 31 is set to a rotational speed that corresponds to the air volume VA2.

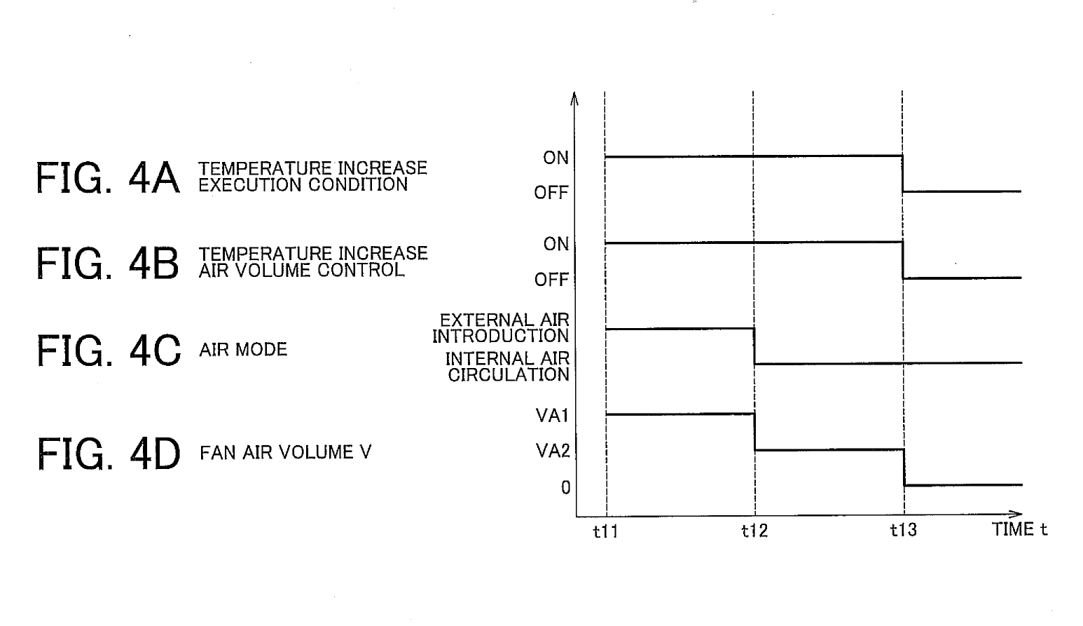

An example of the manner for executing the temperature increase air volume control process will be described with reference to FIG. 4. At time t11 when the external air introduction mode is selected as the air mode in the situation where it is determined that the temperature increase execution condition is satisfied when the operation of the internal combustion engine is started, the fan air volume V is set to the air volume VA1 and the air supply to the secondary battery by the battery fan 31 is started.

At time t12 when the air mode is switched from the external air introduction mode to the internal air circulation mode in the situation where the temperature increase execution condition is satisfied, the fan air volume V is changed from the air volume VA1 to the air volume VA2 that is smaller than the air volume VA1.

At time t13 when the secondary battery temperature TB exceeds the normal temperature reference value TBL and therefore the temperature increase execution condition is no longer satisfied in the situation where the internal air circulation mode is selected as the air mode, the air supply to the secondary battery 40 by the battery fan 31 is stopped.

According to the first embodiment described above, the following effects are obtained. 1) In the first embodiment, the fan air volume V is set based on the degree of introduction of the external air into the vehicle compartment 11. With this configuration, the fan air volume V is set based on the external air introduction degree, which exerts a great influence on the humidity in the vehicle compartment 11. Therefore, it is possible both to reduce the occurrence of condensation in the secondary battery 40 and to increase the temperature of the secondary battery 40 even if a humidity sensor is not provided.

2) In the first embodiment, the fan air volume VA2 that is used when the internal air circulation mode is selected is set to a value that is smaller than the fan air volume VA1 that is used when the external air introduction mode is selected. Thus, it is possible to more reliably reduce the occurrence of condensation in the secondary battery 40.

3) In the first embodiment, when the secondary battery temperature TB is equal to or higher than high temperature reference value TBH, the battery temperature decrease control is executed. Thus, it is possible to reduce the occurrence of the situation where the charge-discharge performance of the secondary battery 40 deteriorates because the secondary battery temperature TB is excessively high.

4) In the first embodiment, when the secondary battery temperature TB is equal to or higher than the high temperature reference value TBH and the secondary battery temperature TB is lower than the vehicle compartment temperature TA, the battery temperature decrease control is refrained from being executed. With this configuration, it is possible to reduce the occurrence of the situation where the secondary battery temperature TB is further increased due to the air supply from the vehicle compartment 11 to the secondary battery 40 that is in the high temperature state.

5) In the first embodiment, when the secondary battery temperature TB is lower than the normal temperature reference value TBL and the secondary battery temperature TB is equal to or higher than the vehicle compartment temperature TA, the battery temperature increase control is refrained from being executed. With this configuration, it is possible to reduce the occurrence of the situation where the secondary battery temperature TB is further decreased due to the air supply from the vehicle compartment 11 to the secondary battery 40 that is in the low temperature state.

6) In the first embodiment, when the secondary battery temperature TB is lower than the high temperature reference value TBH and the secondary battery temperature TB is equal to or higher than the normal temperature reference value TBL, the battery temperature decrease control and the battery temperature increase control are refrained from being executed. With this configuration, it is possible to maintain the secondary battery temperature TB within a temperature range that is appropriate in terms of the input and output characteristics of the secondary battery 40.

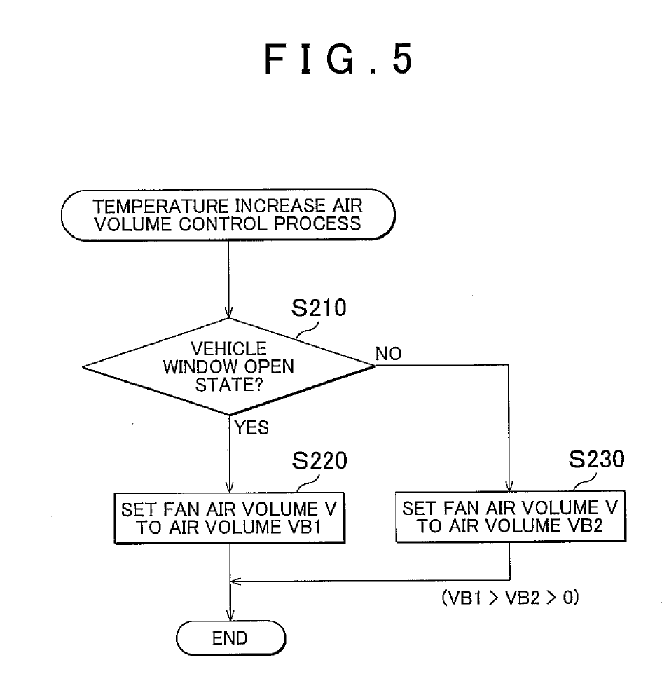

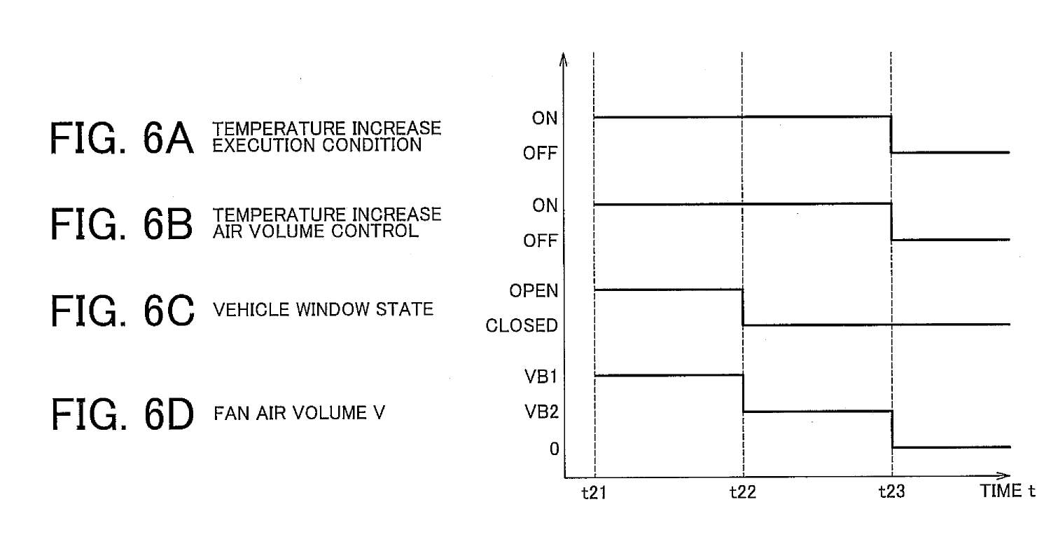

Hereafter, a second embodiment of the invention will be described with reference to FIGS. 5 and 6. The features that differ from those in the first embodiment will be mainly described below. The configurations that are common to those in the first embodiment will be denoted by the same reference numerals as those in the first embodiment, and the description thereof will not be provided below.

In the battery temperature increase control according to the first embodiment, the fan air volume V is set based on whether the air mode is the internal air circulation mode or the external air introduction mode. In contrast, in the battery temperature increase control according to the second embodiment, the fan air volume V is set based on the vehicle window state.

When the vehicle windows are closed, ventilation is not provided in the vehicle compartment 11. Therefore, the humidity in the vehicle compartment 11 is more likely to increase than when the vehicle windows are open. In light of this feature, the fan air volume V (air volume VB2) that is used in the vehicle window closed state is set to a value smaller than the fan air volume V (air volume VB1) that is used in the vehicle window open state, according to the second embodiment. That is, the fan air volume V that is used in the vehicle window closed state where it is estimated that the humidity in the vehicle compartment 11 is high is set to a smaller value. Therefore, it is possible to more reliably reduce the occurrence of condensation in the secondary battery 40.

The temperature increase air volume control process for the battery temperature increase control will be described with reference to FIG. 5. The electronic control unit 51 periodically executes the temperature increase air volume control process at predetermined calculation intervals during the operation of the internal combustion engine.

If it is determined in S210 that the vehicle window state is the open state, the fan air volume V is set to the air volume VB1 in S220. That is, the rotational speed of the battery fan 31 is set to a rotational speed that corresponds to the air volume VB1.

If it is determined in S210 that the vehicle window state is the closed state, the fan air volume V is set to the air volume VB2 that is smaller than the air volume VB1 and larger than 0. That is, the rotational speed of the battery fan 31 is set to a rotational speed that corresponds to the air volume VB2.

Whether the vehicle window state is the open state or the closed state is determined based on the output from the pulse sensor 54. If it is determined that all of the multiple vehicle windows 12 are closed based on the output from the pulse sensor 54, it is determined that the vehicle window state is the closed state. On the other hand, if it is determined that at lease one of the door windows 12 is open, it is determined that the vehicle window state is the open state.

An example of the manner for executing the temperature increase air volume control process will be described with reference to FIG. 6. At time t21 when the vehicle window state is the open state in the situation where it is determined that the temperature increase execution condition is satisfied when the operation of the internal combustion engine is started, the fan air volume V is set to the air volume VB1 and the air supply to the secondary battery 40 by the battery fan 31 is started.

At time t22 when the vehicle window state is changed from the open state to the closed state in the situation where the temperature increase execution condition is satisfied, the fan air volume V is changed from the air volume VB1 to the air volume VB2 that is smaller than the air volume VB1.

At time t23 when the secondary battery temperature TB exceeds the normal temperature reference value TBL and therefore the temperature increase execution condition is no longer satisfied in the situation where the vehicle window state is the closed state, the air supply to the secondary battery 40 by the battery fan 31 is stopped.

According to the second embodiment described above, it is possible to obtain the above-described effect 1) in the first embodiment, that is, it is possible to both reduce the occurrence of condensation in the secondary battery 40 and to increase the temperature of the secondary battery 40 even if a humidity sensor is not provided. In addition, it is possible to obtain the effect similar to the above-described effect 2) in the first embodiment.

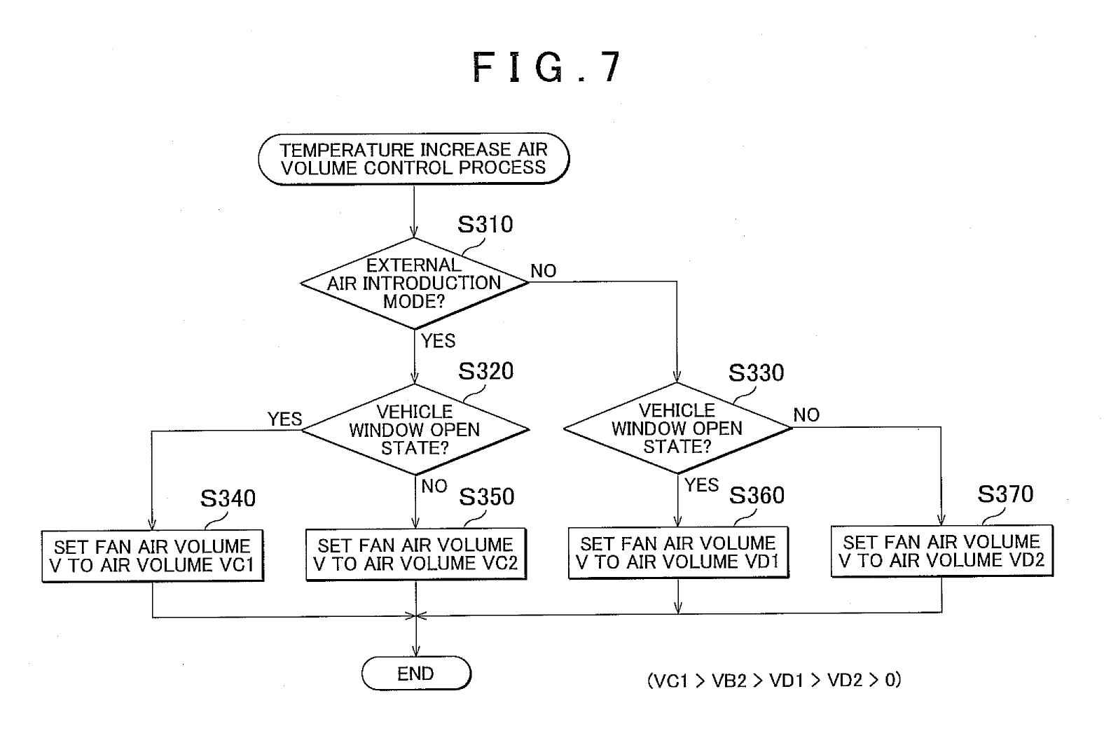

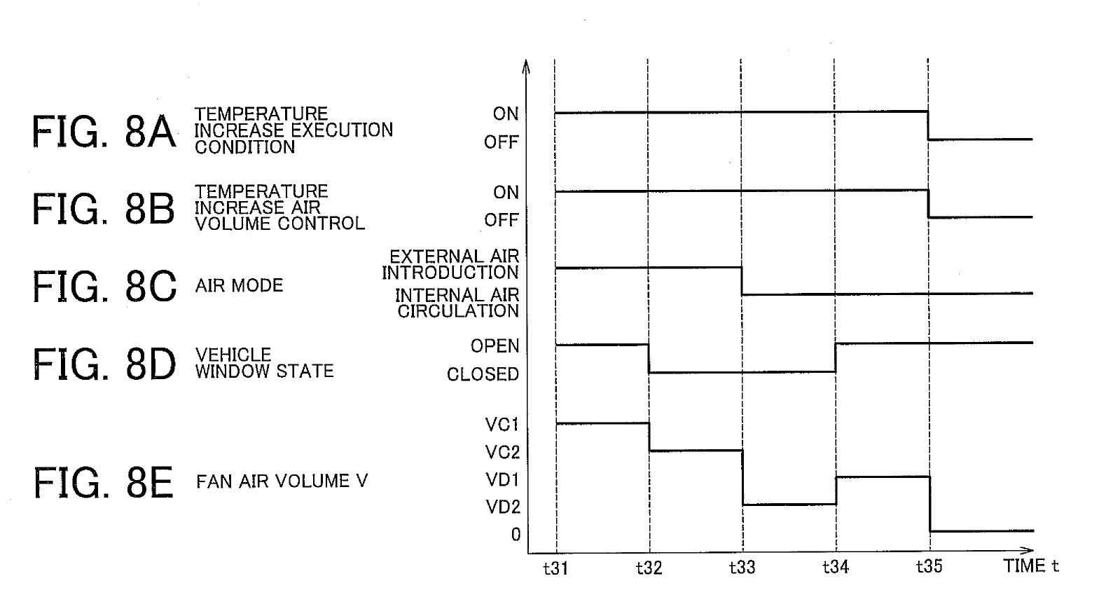

A third embodiment of the invention will be described with reference to FIGS. 7 and 8. The features that differ from those in the first embodiment will be mainly described below. The configurations that are common to those in the first embodiment will be denoted by the same reference numerals as those in the first embodiment, and the description thereof will not be provided below.

In the battery temperature increase control according to the first embodiment, the fan air volume V is set based on whether the air mode is the internal air circulation mode or the external air introduction mode. In contrast, in the battery temperature increase control according to the third embodiment, the fan air volume V is set based on both whether the air mode is the internal air circulation mode or the external air introduction mode and whether the vehicle window state is the open state or the closed state.

The temperature increase air volume control process for the battery temperature increase control will be described with reference to FIG. 7. The electronic control unit 51 periodically executes the temperature increase air volume control process at predetermined calculation intervals during the operation of the internal combustion engine.

In the temperature increase air volume control process, it is determined in S310 whether the external air introduction mode is selected as the air mode, and it is determined in S320 or S330 whether the vehicle window state is the open state. Then, one of the following processes A) to D) is executed based on the determination results.

A) If it is determined that the external air introduction mode is selected as the air mode and the vehicle window state is the open state, the fan air volume V is set to the air volume VC1 in S340. That is, the rotational speed of the battery fan 31 is set to a rotational speed that corresponds to the air volume VC1.

B) If it is determined that the external air introduction mode is selected as the air mode and the vehicle window state is the closed state, the fan air volume V is set to the air volume VC2 that is smaller than the air volume VC1 and larger than 0. That is, the rotational speed of the battery fan 31 is set to a rotational speed that corresponds to the air volume VC2.

C) If it is determined that the internal air circulation mode is selected as the air mode and the vehicle window state is the open state, the fan air volume V is set to the air volume VD1 that is smaller than the air volume VC2 and larger than 0. That is, the rotational speed of the battery fan 31 is set to a rotational speed that corresponds to the air volume VD1.

D) If it is determined that the internal air circulation mode is selected as the air mode and the vehicle window state is the closed state, the fan air volume V is set to the air volume VD2 that is smaller than the air volume VD1 and larger than 0. That is, the rotational speed of the battery fan 31 is set to a rotational speed that corresponds to the air volume VD2.

An example of the manner for executing the temperature increase air volume control process will be described with reference to FIG. 8. At time t31 when the external air introduction mode is selected as the air mode and the vehicle window state is the open state in the situation where it is determined that the temperature increase execution condition is satisfied when the operation of the internal combustion engine is started, the fan air volume V is set to the air volume VC1 and the air supply to the secondary battery 40 by the battery fan 31 is started.

At time t32 when the vehicle window state is switched from the open state to the closed state in the situation where the external air introduction mode is selected and the temperature increase execution condition is satisfied, the fan air volume V is changed from the air volume VC1 to the air volume VC2 that is smaller than the air volume VC1.

At time t33 when the air mode is switched from the external air introduction mode to the internal air circulation mode in the situation where the vehicle window state is the closed state and the temperature increase execution condition is satisfied, the fan air volume V is changed from the air volume VC2 to the air volume VD2 that is smaller than the air volume VC2.

At time t34 when the vehicle window state is switched from the closed state to the open state in the situation where the internal air circulation mode is selected and the temperature increase execution condition is satisfied, the fan air volume V is changed from the air volume VD2 to the air volume VD1 that is larger than the air volume VD2.

At time t35 when the secondary battery temperature TB exceeds the normal temperature reference value TBL and therefore the temperature increase execution condition is no longer satisfied in the situation where the vehicle window state is the open state and the internal air circulation mode is selected, the air supply to the secondary battery 40 by the battery fan 31 is stopped.

According to the third embodiment described above, it is possible to obtain the above-described effect 1) in the first embodiment, that is, it is possible to both reduce the occurrence of condensation in the secondary battery 40 and to increase the temperature of the secondary battery 40 even if a humidity sensor is not provided. In addition, it is possible to obtain the effect similar to the effect 2) in the first embodiment.

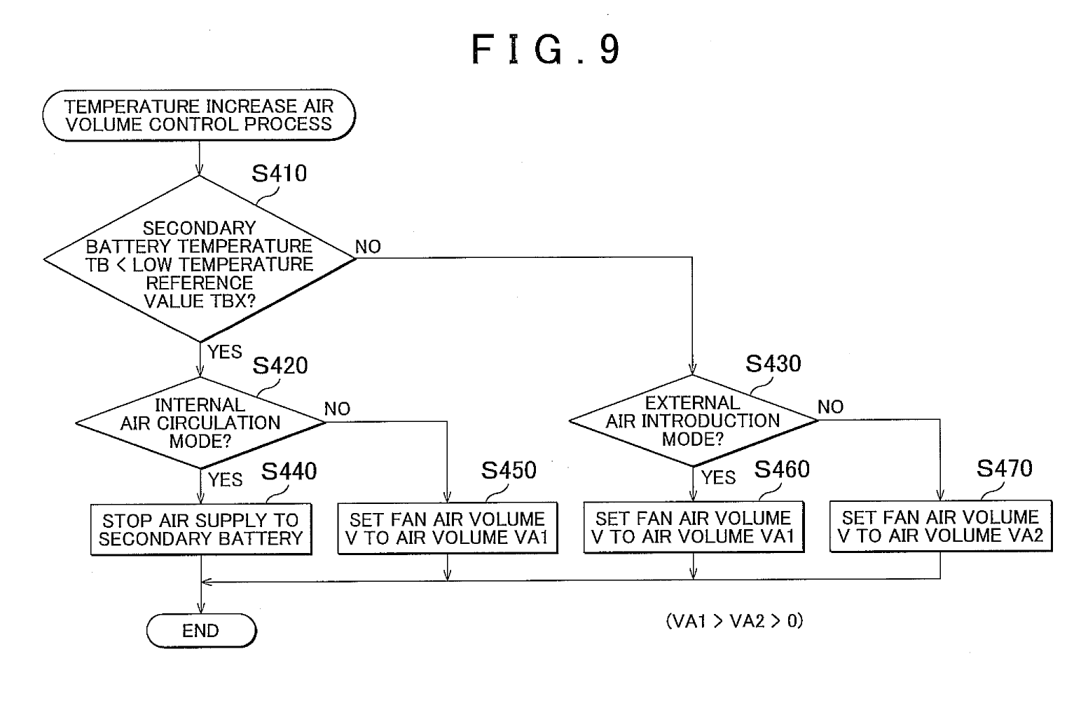

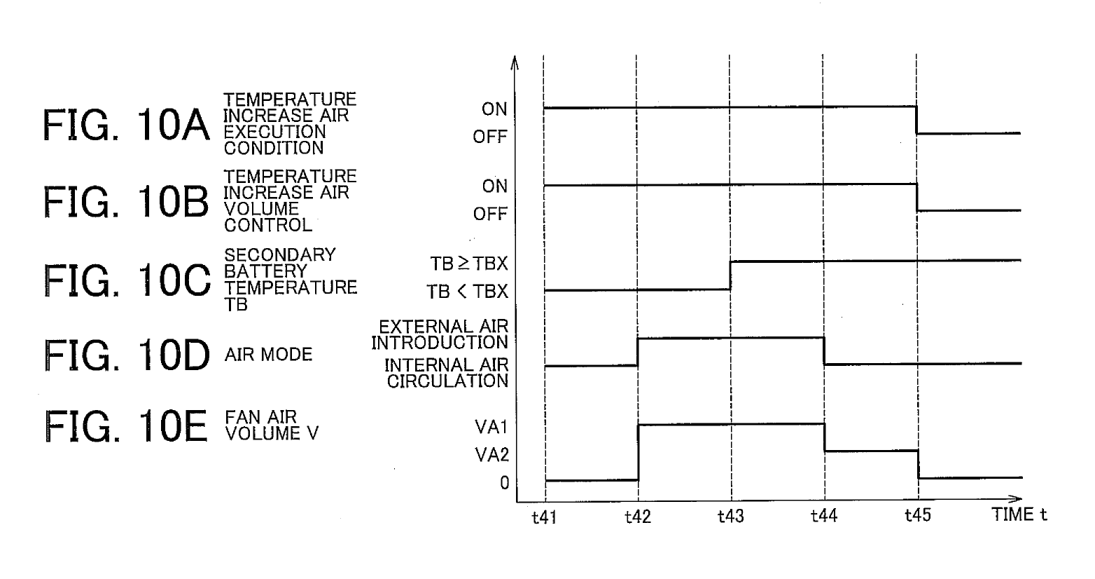

A fourth embodiment of the invention will be described with reference to FIGS. 9 and 10. The features that differ from those in the first embodiment will be mainly described below. The configurations that are common to those in the first embodiment will be denoted by the same reference numerals as those in the first embodiment, and the description thereof will not be provided below.

In the battery temperature control according to the first embodiment, when the secondary battery temperature TB is lower than the normal temperature reference value TBL and the secondary battery temperature TB is lower than the vehicle compartment temperature TA, the air is supplied to the secondary battery 40 through the battery temperature increase control. In contrast, in the battery temperature control according to the fourth embodiment, when the secondary battery temperature TB is lower than the normal temperature reference value TBL and the secondary battery temperature TB is lower than the vehicle compartment temperature TA, the battery temperature increase control itself is executed. However, if it is determined in the battery temperature increase control that the secondary battery temperature TB is lower than the low temperature reference value TBX that is lower than the normal temperature reference value TBL, the fan air volume V is set base on whether the air mode is the internal air circulation mode or the external air introduction mode.

It is confirmed that the air supply to the secondary battery 40 is likely to cause condensation in the secondary battery 40 even under the environment where the humidity is low, if the secondary battery temperature TB falls below the extremely-low temperature reference value TBZ that is lower than the normal temperature reference value TBL and the low temperature reference value TBX (TBL>TBX>TBZ).

On the other hand, if the secondary battery temperature TB is higher than the extremely-low temperature reference value TBZ, although there is basically a low possibility that the air supply to the secondary battery 40 will cause condensation in the secondary battery 40, the likelihood that the condensation will occur increases as the secondary battery temperature TB approaches the extremely-low temperature reference value TBZ. Therefore, if the air having a high humidity is supplied from the vehicle compartment 11 to the secondary battery 40 in this temperature state, the likelihood that the condensation will occur is relatively high even if the secondary battery temperature TB exceeds the extremely-low temperature reference value TBZ.

When the secondary battery temperature TB falls below the low temperature reference value TBX and the internal air circulation mode is selected, the air supply from the vehicle compartment 11 to the secondary battery 40 is stopped. Therefore, it is possible to more reliably reduce the occurrence of condensation in the secondary battery 40.

The temperature increase air volume control process for the battery temperature increase control will be described with reference to FIG. 9. The electronic control unit 51 periodically executes the temperature increase air volume control process at predetermined calculation intervals during the operation of the internal combustion engine.

In the temperature increase air volume control process, it is determined in S410 whether the secondary battery temperature TB is lower than the low temperature reference value TBX. It is determined in S420 whether the internal air circulation mode is selected as the air mode. It is determined in S430 whether the external air introduction mode is selected as the air mode. Then, one of the following processes A) to D) is executed based on the results of determinations.

The low temperature reference value TBX is a value that is used to determine whether there is a high possibility that the air supply from the vehicle compartment 11 to the secondary battery 40 will cause condensation in the situation where the internal air circulation mode is selected as the air mode. The low temperature reference value TBX is derived through, for example, a test, and stored in the electronic control unit 51. That is, when the secondary battery temperature TB is lower than the low temperature reference value TBX, it is estimated that there is a high possibility that the air supply to the secondary battery 40 in the internal air circulation mode will cause condensation in the secondary battery 40 because the battery temperature TB is low.

A) If it is determined that the secondary battery temperature TB is lower than the low temperature reference value TBX and it is determined that the internal air circulation mode is selected as the air mode, the air supply to the secondary battery 40 by the battery fan 31 is stopped in S440.

B) If it is determined that the secondary battery temperature TB is lower than the low temperature reference value TBX and it is determined that the external air introduction mode is selected as the air mode, the fan air volume V is set to the air volume VA1 in S450.

C) If it is determined that the secondary battery temperature TB is equal to or higher than the low temperature reference value TBX and it is determined that the external air introduction mode is selected as the air mode, the fan air volume V is set to the air volume VA1 in S46.

D) If it is determined that the secondary battery temperature TB is equal to or higher than the low temperature reference value TBX and it is determined that the internal air circulation mode is selected as the air mode, the fan air volume V is set to the air volume VA2 in S47.

An example of the manner for executing the temperature increase air volume control process will be described with reference to FIG. 10. At time t41 when the secondary battery temperature TB is lower than the low temperature reference value TBX and the internal air circulation mode is selected as the air mode in the situation where the temperature increase execution condition is satisfied when the operation of the internal combustion engine is started, the air supply to the secondary battery 40 is stopped in the battery temperature increase control.

At time t42 when the air mode is switched from the internal air circulation mode to the external air introduction mode in the situation where the temperature increase execution condition is satisfied and the secondary battery temperature TB is lower than the low temperature reference value TBX, the fan air volume V is set to the air volume VA1 and the air supply to the secondary battery 40 is started.

At time t43 when the secondary battery temperature TB exceeds the low temperature reference value TBX in the situation where the temperature increase execution condition is satisfied and the external air introduction mode is selected as the air mode, the air supply to the secondary battery 40 is continued and the fan air volume V is maintained at the air volume VA1.

At time t44 when the air mode is switched from the external air introduction mode to the internal air circulation mode in the situation where the temperature increase execution condition is satisfied and the secondary battery temperature TB is equal to or higher than the low temperature reference value TBX, the air supply to the secondary battery 40 is continued but the fan air volume V is changed from the air volume VA1 to the air volume VA2 that is smaller than the air volume VA1.

At time t45 when the secondary battery temperature TB exceeds the normal temperature reference value TBL and therefore the temperature increase execution condition is no longer satisfied in the situation where the secondary battery temperature TB is equal to or higher than the low temperature reference value TBX and the internal air circulation mode is selected, the air supply to the secondary battery 40 by the battery fan 31 is stopped.

According to the fourth embodiment described above, it is possible to obtain the above-described effect 1) in the first embodiment, that is, it is possible to both reduce the occurrence of condensation in the secondary battery 40 and to increase the temperature of the secondary battery 40 even if a humidity sensor is not provided. In addition, it is possible to obtain the following effects 7) to 9).

7) In the fourth embodiment, when the secondary battery temperature TB is lower than the low temperature reference value TBX and the internal air circulation mode is selected, the air supply from the vehicle compartment 11 to the secondary battery 40 is stopped. Thus, it is possible to more reliably reduce the occurrence of condensation in the secondary battery 40.

8) In the fourth embodiment, when the secondary battery temperature TB is equal to or higher than the low temperature reference value TBX and the internal air circulation mode is selected, the air is supplied from the vehicle compartment 11 to the secondary battery 40. Thus, it is possible to promptly increase the temperature of the secondary battery 40.

9) In the fourth embodiment, when the secondary battery temperature TB is lower than the low temperature reference value TBX and the external air introduction mode is selected, the air is supplied from the vehicle compartment 11 to the secondary battery 40. Thus, it is possible to promptly increase the secondary battery 40 that is in the low temperature state.

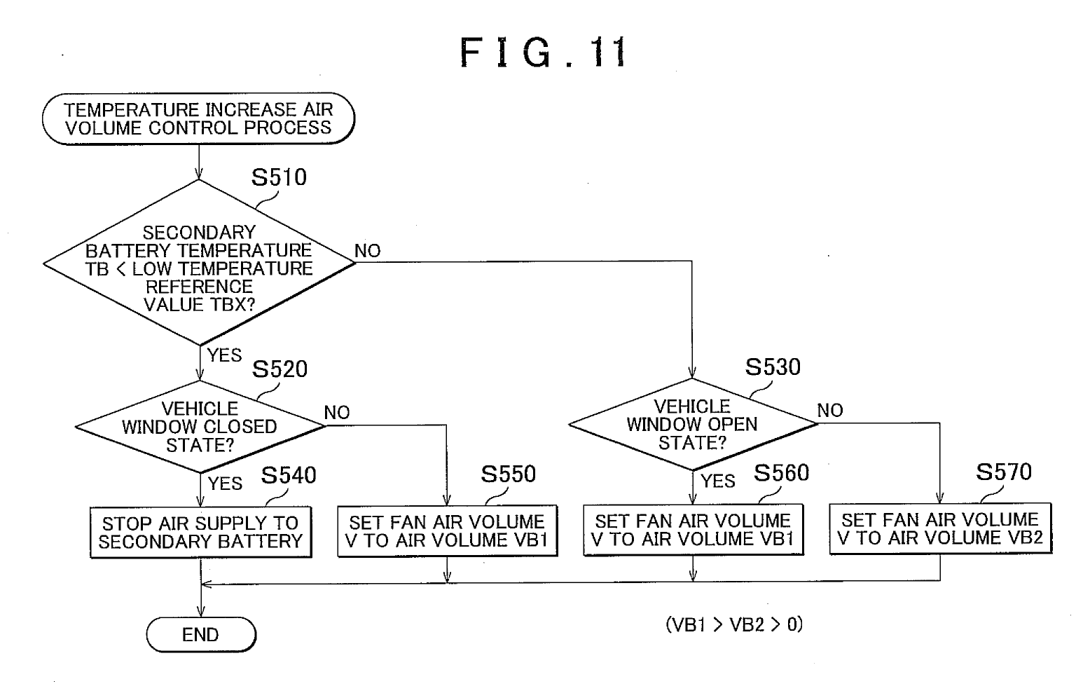

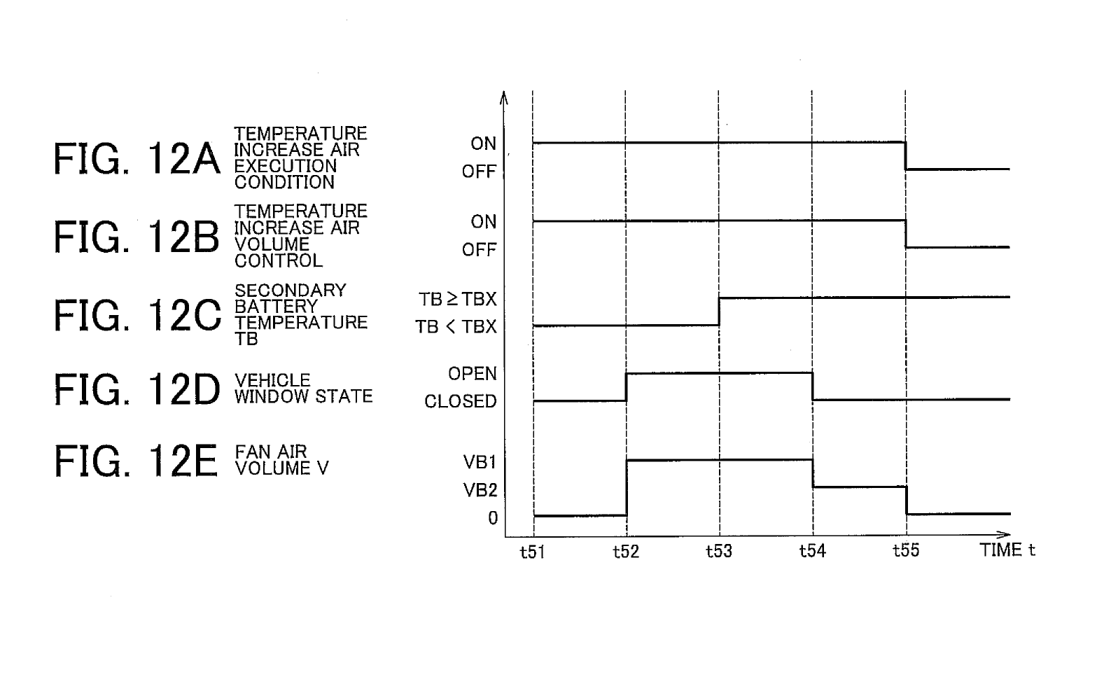

A fifth embodiment of the invention will be described with reference to FIGS. 11 and 12. The features that differ from those in the fourth embodiment will be mainly described below. The configurations that are common to those in the fourth embodiment will be denoted by the same reference numerals as those in the fourth embodiment, and the description thereof will not be provided below.

In the battery temperature increase control according to the fourth embodiment, the fan air volume V is set based on the relationship between the secondary battery temperature TB and the low temperature reference value TBX and whether the air mode is the internal air circulation mode or the external air introduction mode. In contrast, in the battery temperature increase control according to the fifth embodiment, the fan air volume V is set based on the relationship between the secondary battery temperature TB and the low temperature reference value TBX and whether the vehicle window state is the open state or the closed state.

The temperature increase air volume control process for the battery temperature increase control will be described with reference to FIG. 11. The electronic control unit 51 periodically executes the temperature increase air volume control process at predetermined calculation intervals during the operation of the internal combustion engine.

In the temperature increase air volume control process, it is determined in S510 whether the secondary battery temperature TB is lower than the low temperature reference value TBX. It is determined in S520 whether the vehicle window state is the closed state. It is determined in S530 whether the vehicle window state is the open state. Then, one of the following processes A) to D) is executed based on the results of determinations.

A) If it is determined that the secondary battery temperature TB is lower than the low temperature reference value TBX and it is determined that the vehicle window state is the closed state, the air supply to the secondary battery 40 by the battery fan 31 is stopped in S540.

B) If it is determined that the secondary battery temperature TB is lower than the low temperature reference value TBX and it is determined that the vehicle window state is the open state, the fan air volume V is set to the air volume VB1 in S550.

C) If it is determined that the secondary battery temperature TB is equal to or higher than the low temperature reference value TBX and it is determined that the vehicle window state is the open state, the fan air volume V is set to the air volume VB1 in S560.

D) If it is determined that the secondary battery temperature TB is equal to or higher than the low temperature reference value TBX and it is determined that the vehicle window state is the closed state, the fan air volume V is set to the air volume VB2 in S570.

An example of the manner for executing the temperature increase air volume control process will be described with reference to FIG. 12. At time t51 when the secondary battery temperature TB is lower than the low temperature reference value TBX and the vehicle window state is the closed state in the situation where the temperature increase execution condition is satisfied when the operation of the internal combustion engine is started, the air supply to the secondary battery 40 is stopped in the battery temperature increase control.

At time t52 when the vehicle window state is switched from the closed state to the open state in the situation where the temperature increase execution condition is satisfied and the secondary battery temperature TB is lower than the low temperature reference value TBX, the fan air volume V is set to the air volume VB1 and the air supply to the secondary battery 40 is started.

At time t53 when the secondary battery temperature TB exceeds the low temperature reference value TBX in the situation where the temperature increase execution condition is satisfied and the vehicle window state is the open state, the air supply to the secondary battery 40 is continued and the fan air volume V is maintained at the air volume VB1.

At time t54 when the vehicle window state is switched from the open state to the closed state in the situation where the temperature increase execution condition is satisfied and the secondary battery temperature TB is equal to or higher than the low temperature reference value TBX, the air supply to the secondary battery 40 is continued and the fan air volume V is changed from the air volume VB1 to the air volume VB2 that is smaller than the air volume VB1.

At time t55 when the secondary battery temperature TB exceeds the normal temperature reference value TBL and therefore the temperature increase execution condition is no longer satisfied in the situation where the secondary battery temperature TB is equal to or higher than the low temperature reference value TBX and the vehicle window state is the closed state, the air supply to the secondary battery 40 by the battery fan 31 is stopped.

According to the fifth embodiment described above, it is possible to obtain the above-described effect 1) in the first embodiment, that is, it is possible to both reduce the occurrence of condensation in the secondary battery 40 and to increase the temperature of the secondary battery 40 even if a humidity sensor is not provided. In addition, it is possible to obtain the effects similar to the effects 7) to 9) in the fourth embodiment.

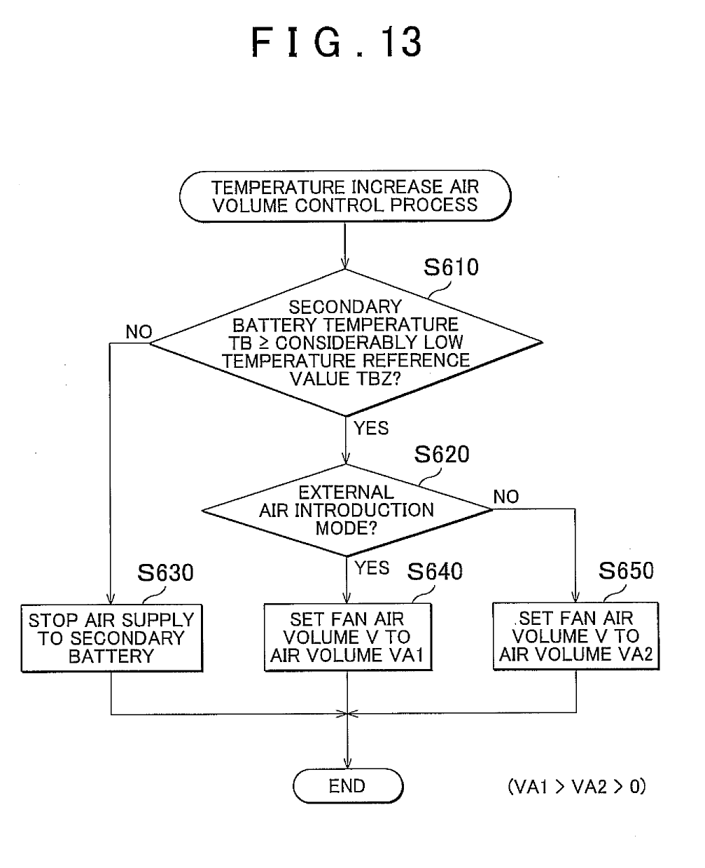

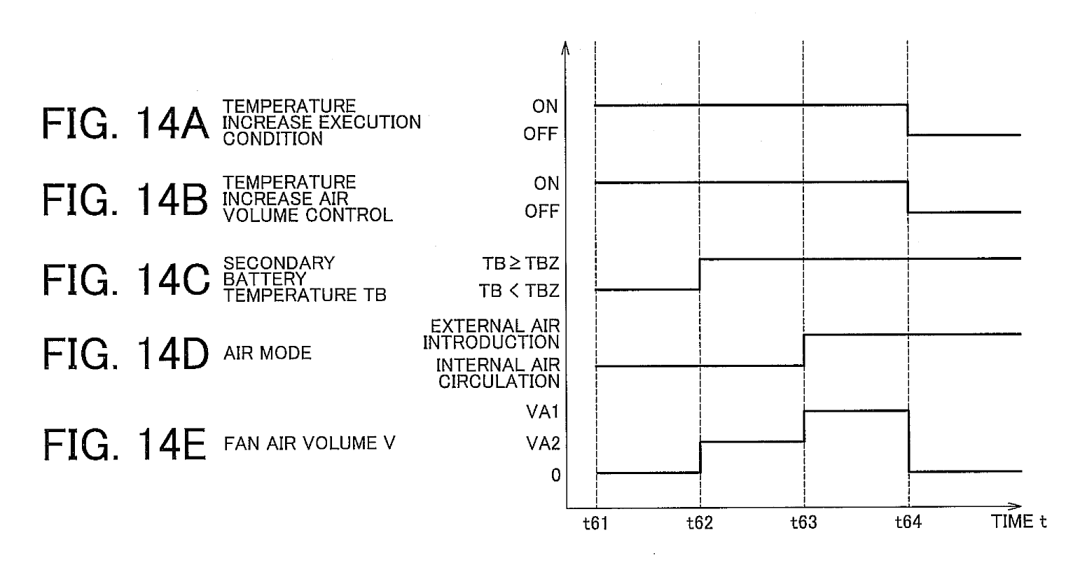

Hereafter, a sixth embodiment of the invention will be described with reference to FIGS. 13 and 14. The features that differ from those in the first embodiment will be mainly described below. The configurations that are common to those in the first embodiment will be denoted by the same reference numerals as those in the first embodiment, and the description thereof will not be provided below.

In the battery temperature control according to the first embodiment, when the secondary battery temperature TB is lower than the normal temperature reference value TBL and the secondary battery temperature TB is lower than the vehicle compartment temperature TA, the air is supplied to the secondary battery 40 through the battery temperature increase control. In contrast, in the battery temperature control according to the sixth embodiment, when the secondary battery temperature TB is lower than the normal temperature reference value TBL and the secondary battery temperature TB is lower than the vehicle compartment temperature TA, the battery temperature increase control itself is executed. However, if it is determined in the battery temperature increase control that the secondary battery temperature TB is lower than the extremely-low temperature reference value TBZ that is lower than the normal temperature reference value TBL, the air supply to the secondary battery 40 is stopped regardless of the relationship between the secondary battery temperature TB and the vehicle compartment temperature TA.

If the secondary battery temperature TB falls below the extremely-low temperature reference value TBZ, the air supply from the vehicle compartment 11 to the secondary battery 40 is stopped. Therefore, it is possible to more reliably reduce the occurrence of condensation in the secondary battery 40.

The temperature increase air volume control process for the battery temperature increase control will be described with reference to FIG. 13. The electronic control unit 51 periodically executes the temperature increase air volume control process at predetermined calculation intervals during the operation of the internal combustion engine.

In the temperature increase air volume control process, it is determined in S610 whether the secondary battery temperature TB is equal to or lower than the extremely-low temperature reference value TBZ, and it is determined in S620 whether the external air introduction mode is selected as the air mode. Then, one of the following processes A) to C) is executed based on the results of determinations.

The extremely-low temperature reference value TBZ is a value that is used to determine whether there is a high possibility that the air supply from the vehicle compartment 11 to the secondary battery 40 will cause condensation in the secondary battery 40. The extremely-low temperature reference value TBZ is derived through, for example, a test and stored in the electronic control unit 51. That is, when the secondary battery temperature TB is lower than the extremely-low temperature reference value TBZ, it is estimated that there is a high possibility that the air supply to the secondary battery 40 will cause condensation in the battery 40 regardless of whether the air mode is the internal air circulation mode or the external air introduction mode because the secondary battery temperature TB is low.

A) If it is determined that the secondary battery temperature TB is lower than the extremely-low temperature reference value TBZ, the air supply to the secondary battery 40 by the battery fan 31 is stopped in S630. B) If it is determined that the secondary battery temperature TB is equal to or higher than the extremely-low temperature reference value TBZ and it is determined that the external air introduction mode is selected as the air mode, the fan air volume V is set to the air volume VA1 in S640.

C) If it is determined that the secondary battery temperature TB is equal to or higher than the extremely-low temperature reference value TBZ and it is determined that the internal air circulation mode is selected as the air mode, the fan air volume V is set to the air volume VA2 in S650.

An example of the manner for executing the temperature increase air volume control process will be described with reference to FIG. 14. At time t61 when the secondary battery temperature TB is lower than the extremely-low temperature reference value TBZ in the situation where the temperature increase execution condition is satisfied when the operation of the internal combustion engine is started, the air supply to the secondary battery 40 is stopped in the battery temperature increase control.

At time t62 when the secondary battery temperature TB exceeds the extremely-low temperature reference value TBZ in the situation where the temperature increase execution condition is satisfied and the internal air circulation mode is selected as the air mode, the fan air volume V is set to the air volume VA2 and the air supply to the secondary battery 40 is started.

At time t63 when the air mode is switched from the internal air circulation mode to the external air introduction mode in the situation where the temperature increase execution condition is satisfied and the secondary battery temperature TB is equal to or higher than the extremely-low temperature reference value TBZ, the air supply to the secondary battery 40 is continued and the fan air volume V is changed from the air volume VA2 to the air volume VA1 that is larger than the air volume VA2.

At time t64 when the secondary battery temperature TB exceeds the normal temperature reference value TBL and therefore the temperature increase execution condition is no longer satisfied in the situation where the secondary battery temperature TB is equal to or higher than the extremely-low temperature reference value TBZ and the external air introduction mode is selected, the air supply to the secondary battery 40 by the battery fan 31 is stopped.

According to the sixth embodiment described above, it is possible to obtain the above-described effect 1) according to the first embodiment, that is, it is possible to both reduce the occurrence of condensation in the secondary battery 40 and to increase the temperature of the secondary battery 40 even if a humidity sensor is not provided. In addition, it is possible to obtain the following effect 10).

10) In the sixth embodiment, when the secondary battery temperature TB is lower than the extremely-low temperature reference value TBZ, the air supply from the vehicle compartment 11 to the secondary battery 40 through the battery temperature increase control is stopped. Thus, it is possible to more reliably reduce the occurrence of condensation in the secondary battery 40.

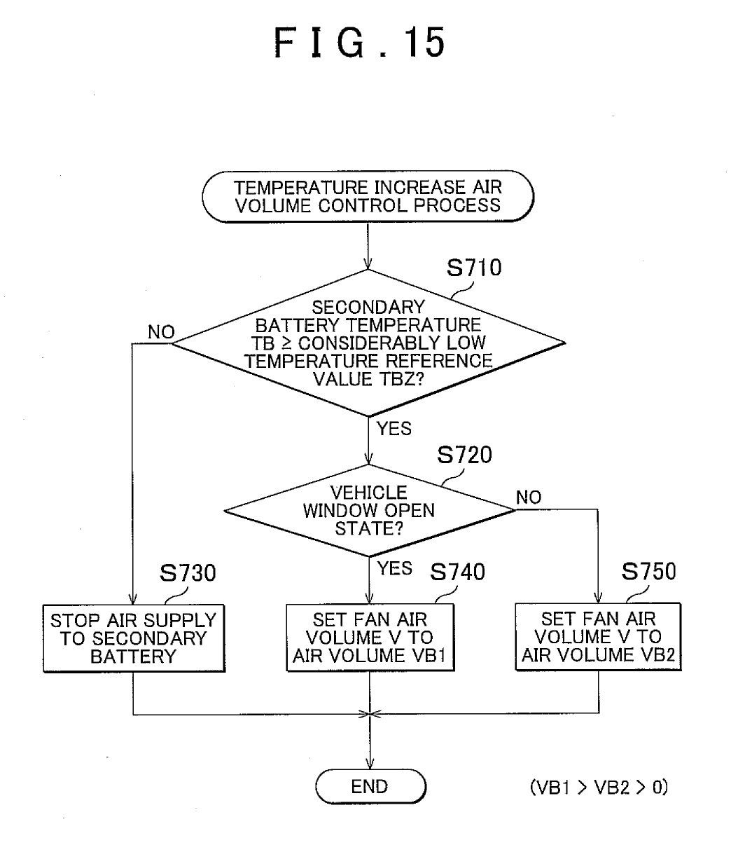

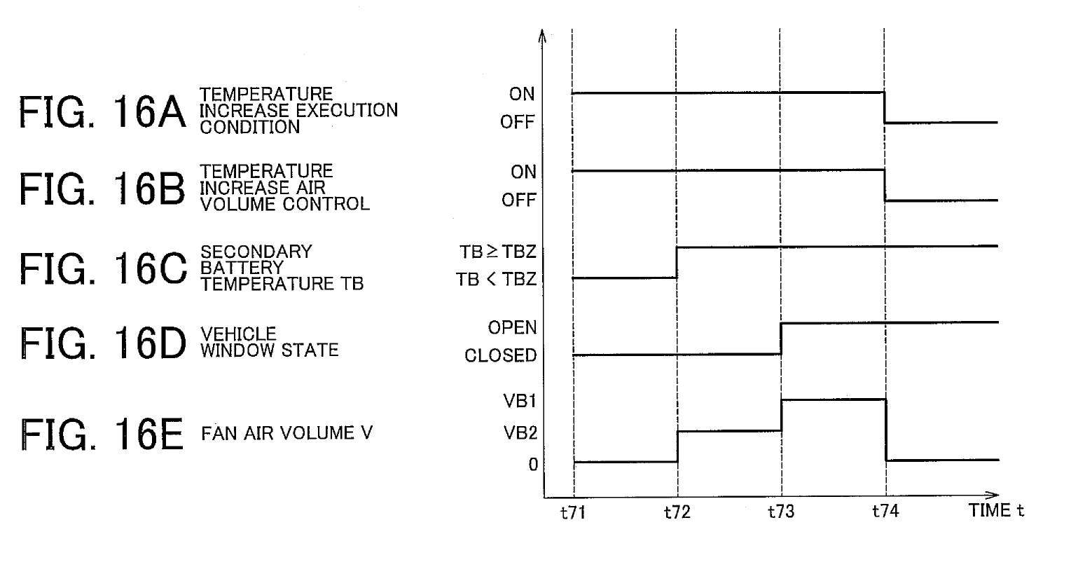

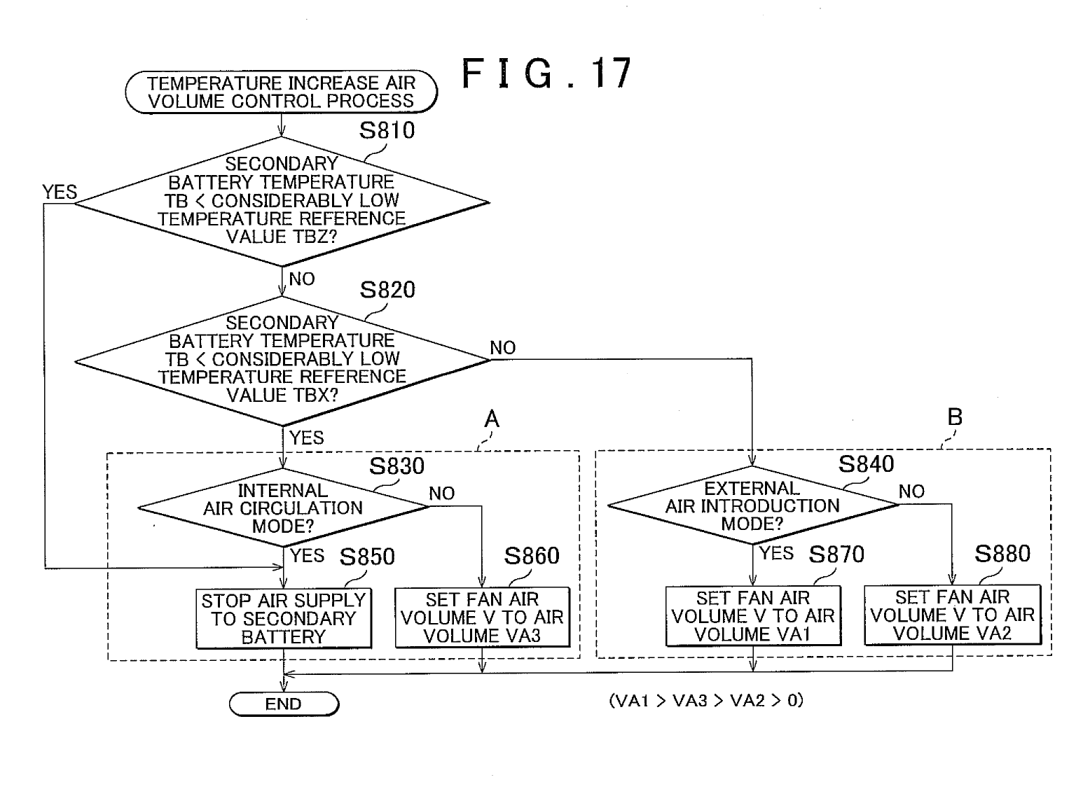

Hereafter, a seventh embodiment of the invention will be described with reference to FIGS. 15 and 16. The features that differ from those in the sixth embodiment will be mainly described below. The configurations that are common to those in the sixth embodiment will be denoted by the same reference numerals as those in the sixth embodiment, and the description thereof will not be provided below.

In the battery temperature control according to the sixth embodiment, if it is determined that the secondary battery temperature TB is equal to or higher than the extremely-low temperature reference value TBZ, the fan air volume V is set based on whether the air mode is the internal air circulation mode or the external air introduction mode. In contrast, in the battery temperature control according to the seventh embodiment, if it is determined that the secondary battery temperature TB is equal to or higher than the extremely-low temperature reference value TBZ, the fan air volume V is set based on whether the vehicle window state is the open state or the closed state.

The temperature increase air volume control process for the battery temperature increase control will be described with reference to FIG. 15. The electronic control unit 51 periodically executes the temperature increase air volume control process at predetermined calculation intervals during the operation of the internal combustion engine.

In the temperature increase air volume control process, it is determined in S710 whether the secondary battery temperature TB is lower than the extremely-low temperature reference value TBZ, and it is determined in S720 whether the vehicle window state is the open state. The, one of the following processes A) to C) is executed based on the results of determinations.

A) If it is determined that the secondary battery temperature TB is lower than the extremely-low temperature reference value TBZ, the air supply to the secondary battery 40 by the battery fan 31 is stopped in S730. B) If it is determined that the secondary battery temperature TB is equal to or higher than the extremely-low temperature reference value TBZ and it is determined that the vehicle window state is the open state, the fan air volume V is set to the air volume VB1 in S740.

C) If it is determined that the secondary battery temperature TB is equal to or higher than the extremely-low temperature reference value TBZ and it is determined that the vehicle window state is the closed state, the fan air volume V is set to the air volume VB2 in S750.

An example of the manner for executing the temperature increase air volume control process will be described with reference to FIG. 16. At time t71 when the secondary battery temperature TB is lower than the extremely-low temperature reference value TBZ in the situation where the temperature increase execution condition is satisfied when the operation of the internal combustion engine is started, the air supply to the secondary battery 40 is stopped in the battery temperature increase control.

At time t72 when the secondary battery temperature TB exceeds the extremely-low temperature reference value TBZ in the situation where the temperature increase execution condition is satisfied and the and vehicle window state is the closed state, the fan air volume V is set to the air volume VB2 and the air supply to the secondary battery 40 is started.

At time t73 when the vehicle window state is switched from the closed state to the open state in the situation where the temperature increase execution condition is satisfied and the secondary battery temperature TB is equal to or higher than the extremely-low temperature reference value TBZ, the air supply to the secondary battery 40 is continued and the fan air volume V is changed from the air volume VB2 to the air volume VB1 that is larger than the air volume VB2.

At time t74 when the secondary battery temperature TB exceeds the normal temperature reference value TBL and therefore the temperature increase execution condition is no longer satisfied in the situation where the secondary battery temperature TB is equal to or higher than the extremely-low temperature reference value TBZ and the vehicle window state is the open state, the air supply to the secondary battery 40 by the battery fan 31 is stopped.

According to the seventh embodiment described above, it is possible to obtain the above-described effect 1) in the first embodiment, that is, it is possible to both reduce the occurrence of condensation in the secondary battery 40 and to increase the temperature of the secondary battery 40 even if a humidity sensor is not provided. In addition, it is possible to obtain the effect similar to the effect 10) in the sixth embodiment.

An eighth embodiment of the invention will be described with reference to FIG. 17. The features that differ from those in the fourth embodiment will be mainly described below. The configurations that are common to those in the fourth embodiment will be denoted by the same reference numerals as those in the fourth embodiment, and the description thereof will not be provided below.

In the battery temperature control according to the fourth embodiment, the fan air volume V is set based on the relationship between the secondary battery temperature TB and the low temperature reference value TBX and whether the air mode is the internal air circulation mode or the external air introduction mode. In contrast, in the battery temperature increase control according to the eighth embodiment, the fan air volume V is set based on the relationship between the secondary battery temperature TB and the extremely-low temperature reference value TBZ, the relationship between the secondary battery temperature TB and the low temperature reference value TBX, and whether the air mode is the internal air circulation mode or the external air introduction mode.

The temperature increase air volume control process for the battery temperature increase control will be described with reference to FIG. 17. The electronic control unit 51 periodically executes the temperature increase air volume control process at predetermined calculation intervals during the operation of the internal combustion engine.

In the temperature increase air volume control process, it is determined in S810 whether the secondary battery temperature TB is lower than the extremely-low temperature reference value TBZ. It is determined in S820 whether the secondary battery temperature TB is lower than the low temperature reference value TBX. It is determined in S830 whether the internal air circulation mode is selected as the air mode. It is determined whether S840 whether the external air introduction mode is selected as the air mode. Then, one of the following processes A) to E) is executed based on the results of determinations.

A) If it is determined that the secondary battery temperature TB is equal to or higher than the extremely-low temperature reference value TBZ, it is determined that the secondary battery temperature TB is lower than the low temperature reference value TBX, and it is determined that the internal air circulation mode is selected as the air mode, the air supply to the secondary battery 40 by the battery fan 31 is stopped.

B) If it is determined that the secondary battery temperature TB is equal to or higher than the extremely-low temperature reference value TBZ, it is determined that the secondary battery temperature TB is lower than the low temperature reference value TBX, and it is determined that the external air introduction mode is selected as the air mode, the fan air volume V is set to the air volume VA3 that is larger than the air volume VA2 and smaller than the air volume VA1.

C) If it is determined that the secondary battery temperature TB is equal to or higher than the low temperature reference value TBX and it is determined that the external air introduction mode is selected as the air mode, the fan air volume V is set to the air volume VA1 in S870.

D) If it is determined that the secondary battery temperature TB is equal to or higher than the low temperature reference value TB and it is determined that the internal air circulation mode is selected as the air mode, the fan air volume V is set to the air volume VA2 that is smaller than the air volume VA3 in S880.

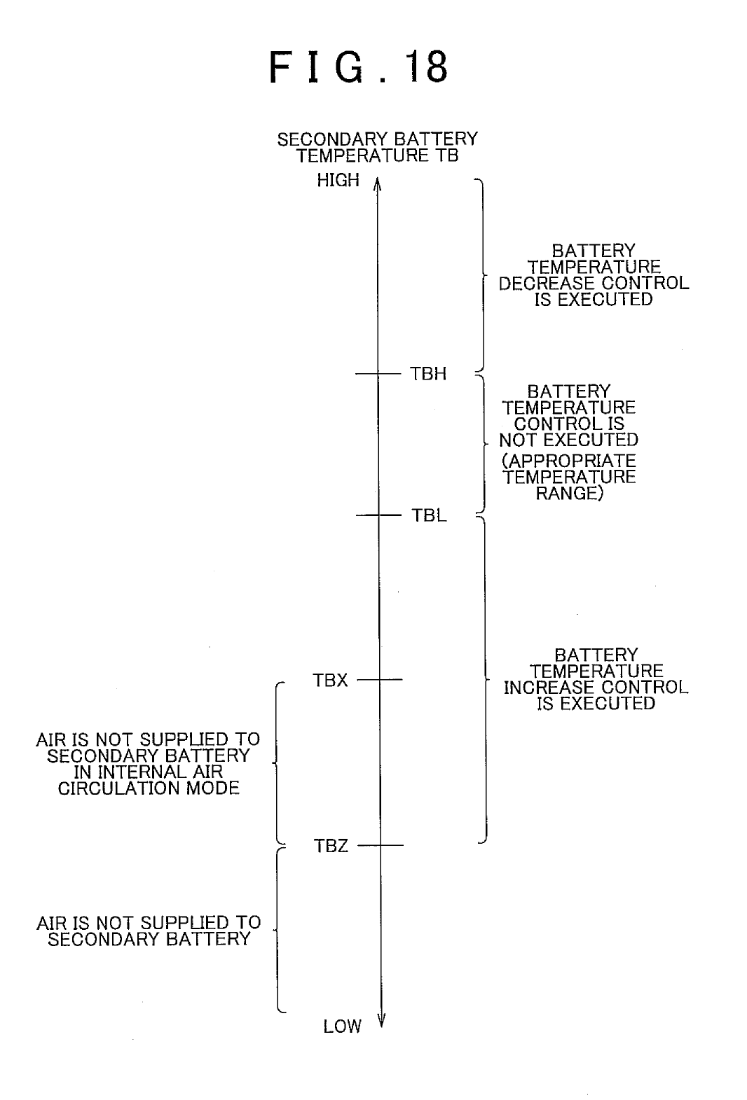

E) If it is determined that the secondary battery temperature TB is lower than the extremely-low temperature reference value TBZ, the air supply to the secondary battery 40 by the battery fan 31 is stopped in S850. FIG. 18 shows the relationship between each reference value used in the battery temperature control and the manner for executing the battery temperature control.

When the secondary battery temperature TB is equal to or higher than the high temperature reference value TBH, the battery temperature decrease control is executed as the battery temperature control. When the secondary battery temperature TB is lower than the high temperature reference value TBH and equal to or higher than the normal temperature reference value TBL, the battery temperature decrease control and the battery temperature increase control are not executed. When the secondary battery temperature TB is lower than the normal temperature reference value TBL and equal to or higher than the low temperature reference value TBX, the battery temperature increase control is executed as the battery temperature control. When the secondary battery temperature TB is lower than the low temperature reference value TBX and equal to or higher than the extremely-low temperature reference value TBZ, the battery temperature increase control is executed as the battery temperature control on the condition that the external air introduction mode is selected as the air mode. When the secondary battery temperature TB is lower than the extremely-low temperature reference value TBZ, the battery temperature increase control is not executed.

According to the eighth embodiment described above, it is possible to obtain the above-described effect 1) in the first embodiment, that is, it is possible to both reduce the occurrence of condensation in the secondary battery 40 and to increase the temperature of the secondary battery 40 even if a humidity sensor is not provided. In addition, it is possible to obtain the effect similar to the effects 7) to 9) in the fourth embodiment, and the effect similar to the effect 10) in the sixth embodiment.

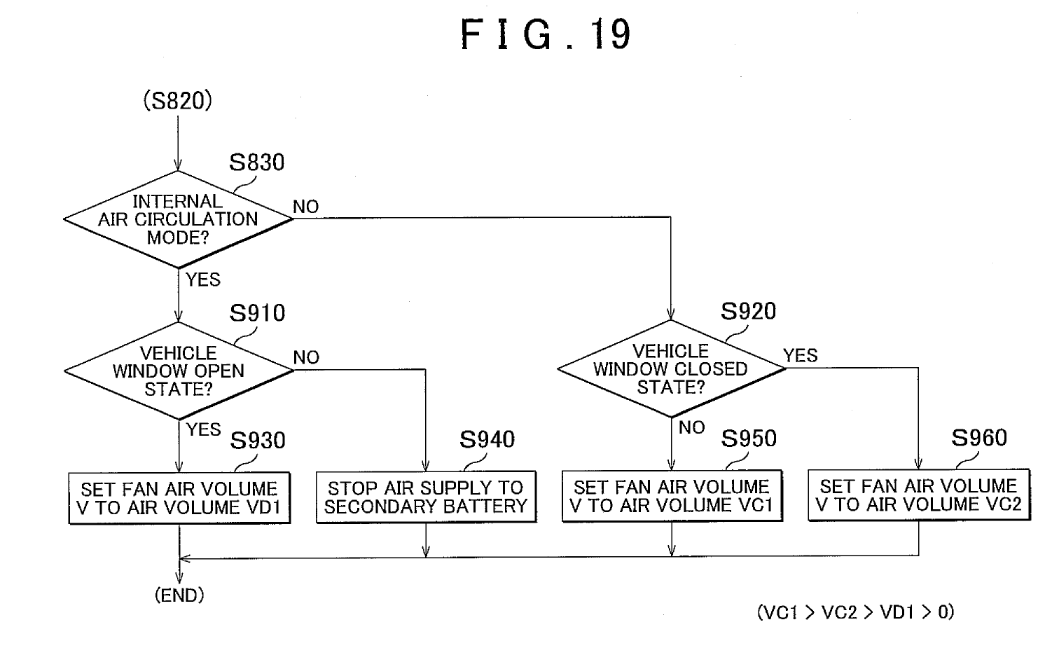

Hereafter, a ninth embodiment of the invention will be described with reference to FIG. 19. The features that differ from those in the eighth embodiment will be mainly described below. The configurations that are common to those in the eighth embodiment will be denoted by the same reference numerals as those in the eighth embodiment, and the description thereof will not be provided below.

The battery temperature increase control according to the ninth embodiment is configured by replacing the process A surrounded by a dashed line in the battery temperature increase control (FIG. 17) in the eighth embodiment to the process shown in FIG. 19, and the other configurations are the same as those in the eighth embodiment.

The temperature increase air volume control process for the battery temperature increase control will be described with reference to FIG. 19. The electronic control unit 51 periodically executes the temperature increase air volume control process at predetermined calculation intervals during the operation of the internal combustion engine.

In the battery temperature increase control process, it is determined in S830 in FIG. 17 whether the internal air circulation mode is selected as the air mode. It is determined in S910 whether the vehicle window state is the open state. It is determined in S920 whether the vehicle window state is the closed state. Then, one of the following processes A) to E) is executed based on the results of determinations.

A) If it is determined that the internal air circulation mode is selected as the air mode and it is determined that the vehicle window state is the open state, the fan air volume V is set to the air volume VD1 that is smaller than the air volume VC2 and larger than 0 in S930.

B) If it is determined that the internal air circulation mode is selected as the air mode and it is determined that the vehicle window state is the closed state, the air supply to the secondary battery 40 by the battery fan 31 is stopped in S940.

C) If it is determined that the external air introduction mode is selected as the air mode and it is determined that the vehicle window state is the open state, the fan air volume V is set to the air volume VC1 in S950.

D) If it is determined that the external air introduction mode is selected as the air mode and it is determined that the vehicle window state is the closed state, the fan air volume V is set to the air volume VC2 that is smaller than the air volume VC1 and larger than 0 in S960.

According to the ninth embodiment described above, it is possible to obtain the above-described effect 1) in the first embodiment, that is, it is possible to both reduce the occurrence of condensation in the secondary battery 40 and to increase the temperature of the secondary battery 40 even if a humidity sensor is not provided. In addition, it is possible to obtain the effects 7) to 9) in the fourth embodiment and the effect similar to the effect 10) in the sixth embodiment.

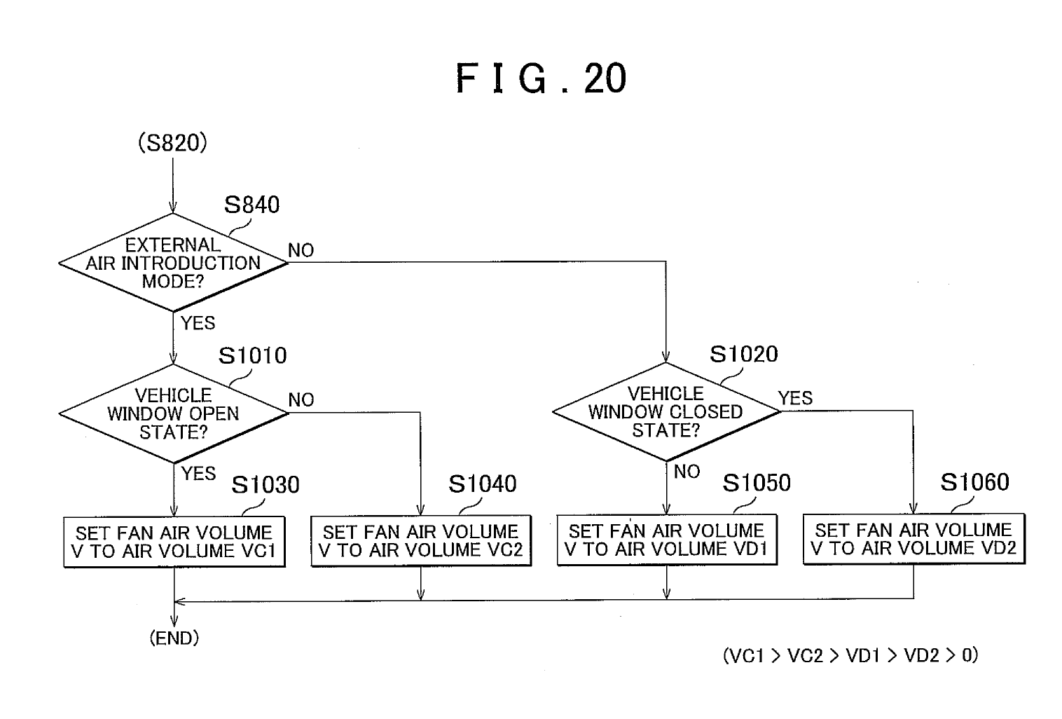

Hereafter, a tenth embodiment of the invention will be described with reference to FIG. 20. The features that differ from those in the eighth embodiment will be mainly described below. The configurations that are common to those in the eighth embodiment will be denoted by the same reference numerals as those in the eighth embodiment, and the description thereof will not be provided below.

The battery temperature increase control according to the tenth embodiment is configured by replacing the process B surrounded by a dashed line in the battery temperature increase control (FIG. 17) in the eighth embodiment to the process shown in FIG. 20, and the other configurations are the same as those in the eighth embodiment.

The temperature increase air volume control process for the battery temperature increase control will be described with reference to FIG. 20. The electronic control unit 51 periodically executes the temperature increase air volume control process at predetermined calculation intervals during the operation of the internal combustion engine.

In the temperature increase air volume control process, it is determined in S840 in FIG. 17 whether the external air introduction mode is selected as the air mode. It is determined in S1010 whether the vehicle window state is the open state. It is determined in S1020 whether the vehicle window state is the closed state. Then, one of the following processes A) to E) is executed based on the results of determinations.

A) If it is determined that the external air introduction mode is selected as the air mode and it is determined that the vehicle window state is the open state, the fan air volume V is set to the air volume VC1 in S1030.

B) If it is determined that the external air introduction mode is selected as the air mode and it is determined that the vehicle window state is the closed state, the fan air volume V is set to the air volume VC2 that is smaller than the air volume VC1 and larger than 0 in S1040.

C) If it is determined that the internal air circulation mode is selected as the air mode and it is determined that the vehicle window state is the open state, the fan air volume V is set to the air volume VD1 that is smaller than the air volume VC2 and larger than 0 in S1050.

D) If it is determined that the internal air circulation mode is selected as the air mode and it is determined that the vehicle window is the closed state, the fan air volume V is set to the air volume VD2 that is smaller than the air volume VD1 and larger than 0 in S1060.

According to the tenth embodiment described above, it is possible to obtain the above-described effect 1) in the first embodiment, that is, it is possible to both reduce the occurrence of condensation in the secondary battery 40 and to increase the temperature of the secondary battery 40 even if a humidity sensor is not provided. In addition, it is possible to obtain the effects 7) to 9) in the fourth embodiment and the effect similar to the effect 10) in the sixth embodiment.

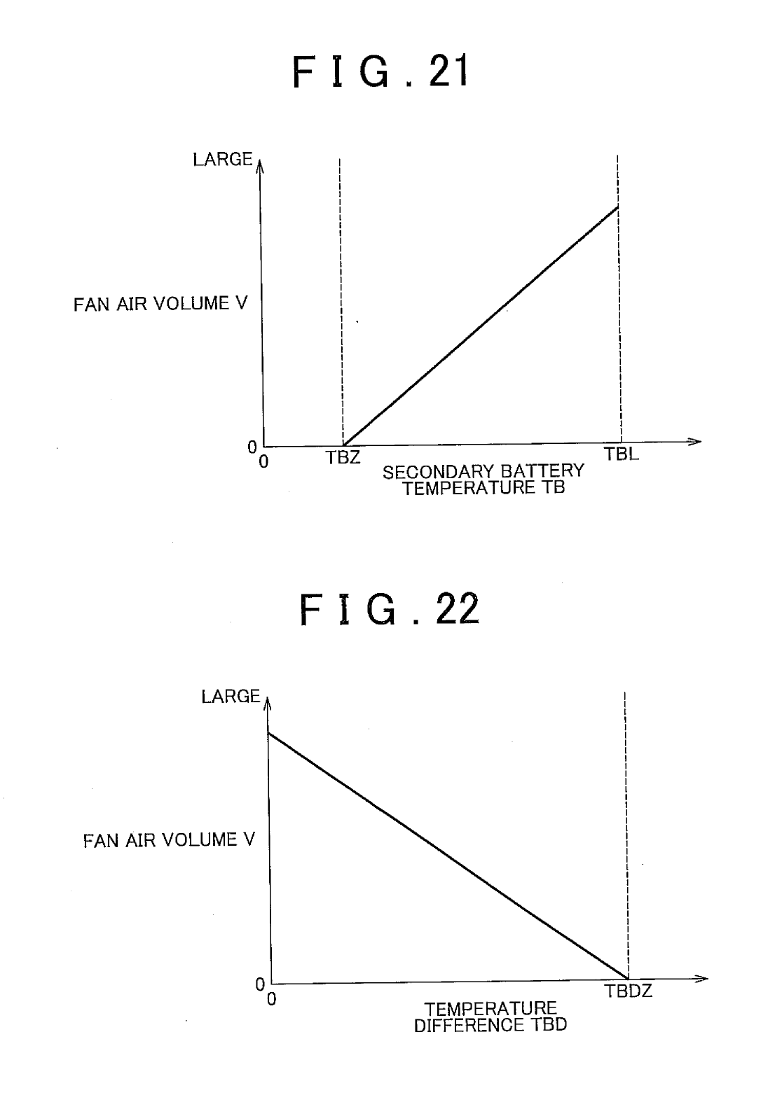

Hereafter, an eleventh embodiment of the invention will be described with reference to FIG. 21. The features that differ from those in the first embodiment will be mainly described below. The configurations that are common to those in the first embodiment will be denoted by the same reference numerals as those in the first embodiment, and the description thereof will not be provided below.

In the battery temperature increase control according to the first embodiment, the fan air volume V is set to the air volume VA1 or the air volume VA2 based on whether the external air introduction degree. In contrast, in the battery temperature increase control according to the eleventh embodiment, the fan air volume V is variably set based on the secondary battery temperature TB.

As shown in FIG. 21, the fan air volume V is increased as the secondary battery temperature TB increases when the secondary battery temperature TB is within the temperature range equal to or higher than the extremely-low temperature reference value TBZ and lower than the normal temperature reference value TBL. When the secondary battery temperature TB is the maximum value within the temperature range (when the secondary battery temperature TB is lower than and closest possible to the normal temperature reference value TBL), the fan air volume V is set to the maximum value within the temperature range. When the secondary battery temperature TB is the extremely-low temperature reference value TBZ, that is, the lowest temperature within the temperature range, the fan air volume V is set to 0. The fan air volume V is set to 0 when the secondary battery temperature TB is within the temperature range lower than the extremely-low temperature reference value TBZ. That is, the air is not supplied to the secondary battery 40 when the secondary battery temperature TB is within the temperature range lower than the extremely-low temperature reference value TBZ.

According to the eleventh embodiment described above, it is possible to obtain the above-described effect 1) in the first embodiment, that is, it is possible to both reduce the occurrence of condensation in the secondary battery 40 and to increase the temperature of the secondary battery 40 even if a humidity sensor is not provided. In addition, it is possible to obtain the effect 11) described below.

11) In the eleventh embodiment, the fan air volume V is decreased as the secondary battery temperature TB decreases. Thus, it is possible to more reliably reduce the occurrence of condensation in the secondary battery 40.

Hereafter, a twelfth embodiment of the invention will be described with reference to FIG. 22. The features that differ from those in the eleventh embodiment will be mainly described below. The configurations that are common to those in the eleventh embodiment will be denoted by the same reference numerals as those in the eleventh embodiment, and the description thereof will not be provided below.

In the battery temperature increase control according to the eleventh embodiment, the fan air volume V is variably set based on the secondary battery temperature TB. In contrast, in the battery temperature increase control according to the twelfth embodiment, the fan air volume V is variably set based on the difference between the vehicle compartment temperature TA and the secondary battery temperature TB (hereinafter, referred to as “temperature difference TBD”).

As shown in FIG. 22, the fan air volume V is decreased as the temperature difference TBD increases when the temperature difference TBD is within the temperature difference range equal to or larger than 0 and smaller than the temperature difference reference value TBDZ. When the temperature difference TBD is 0, which is the minimum value within the temperature difference range, the fan air volume V is set to the maximum value within the temperature difference range. When the temperature difference TBD is the maximum value within the temperature difference range (when the temperature difference TBD is smaller than and closest possible to the temperature difference reference value TBDZ), the fan air volume V is set to 0. That is, the air is not supplied to the secondary battery 40 when the temperature difference TBD is within the temperature difference range equal to or larger than the temperature difference reference value TBDZ.

When the temperature difference TBD is 0, the air supply to the secondary battery 40 will not increase the secondary battery temperature TB. Therefore, the air supply to the secondary battery 40 may be stopped. However, if the air is supplied to the secondary battery 40, the secondary battery temperature TB is maintained. Therefore, the maximum fan air volume V is set as described above, in the twelfth embodiment.

The temperature difference reference value TBDZ is a value used to determine whether there is a high possibility that the air supply from the vehicle compartment 11 to the secondary battery 40 will cause condensation in the secondary battery 40. The temperature difference reference value TBDZ is derived through, for example, a test, and stored in the electronic control unit 51. When the temperature difference TBD is equal to or larger than the temperature difference reference value TBDZ, it is estimated that there is a high possibility that the air supply to the secondary battery 40 will cause condensation in the secondary battery 40 because the secondary battery temperature TB is excessively lower than the vehicle compartment temperature TA.

According to the twelfth embodiment described above, it is possible to obtain the above-described effect 1) in the first embodiment, that is, it is possible to both reduce the occurrence of condensation in the secondary battery 40 and to increase the temperature of the secondary battery 40 even if a humidity sensor is not provided. In addition, it is possible to obtain the effect 12) described below.

12) In the twelfth embodiment, when the temperature difference TBD is equal to or larger than the temperature difference reference value TBDZ, the air supply from the vehicle compartment 11 to the secondary battery 40 is stopped. Thus, it is possible to more reliably reduce the occurrence of condensation in the secondary battery 40.

The invention is not limited to the embodiments described above. For example, the following modifications may be made. The following modifications are applied not only to the embodiments described above. The modifications may be combined with each other.

The fan air volume V in each of the first embodiment, the fourth embodiment, the sixth embodiment, and the eighth embodiment may be changed. That is, in the battery temperature increase control according to each embodiment, the air volume VA2 that is used in the internal air circulation mode is set to the air volume that is smaller than the air volume VA1, which is used in the external air introduction mode, and larger than 0. Alternatively, the air volume VA2 that is used in the internal air circulation mode may be set to 0, that is, the air supply to the secondary battery 40 may be stopped in the internal air circulation mode.

The fan air volume V in each of the first embodiment, the fourth embodiment, the sixth embodiment and the eighth embodiment may be changed. The air volume VA1 and the air volume VA2 in each embodiment may be set based on the secondary battery temperature TB, as shown in FIG. 21. That is, the air volume VA1 and the air volume VA2 may be increased as the secondary battery temperature TB increases.

The fan air volume V in each of the first embodiment, the fourth embodiment, the sixth embodiment and the eighth embodiment may be changed. The air volume VA1 and the air volume VA2 in each embodiment may be set based on the temperature difference TBD as shown in FIG. 22. That is, the air volume VA1 and the air volume VA2 may be increased as the temperature difference TBD decreases.

The fan air volume V in each of the second embodiment, the fifth embodiment and the seventh embodiment may be changed. In the battery temperature increase control, the fan air volume VB2, which is used when the vehicle window state is the closed state, is set to the air volume that is smaller than the fan air volume VB1, which is used when the vehicle window state is the open state, and larger than 0. Alternatively, the fan air volume VB2, which is used when the vehicle window state is the closed state, may be set to 0. That is, the air supply to the secondary battery 40 may be stopped when the vehicle window state is the closed state.

The fan air volume V in each of the second embodiment, the fifth embodiment and the seventh embodiment may be changed. The air volume VB1 and the air volume VB2 in each embodiment may be set based on the secondary battery temperature TB, as shown in FIG. 21. That is, the air volume VB1 and the air volume VB2 may be increased as the secondary battery temperature TB increases.

The fan air volume V in each of the second embodiment, the fifth embodiment and the seventh embodiment may be changed. The air volume VB1 and the air volume VB2 in each embodiment may be set based on the temperature difference TBD, as shown in FIG. 22. That is, the air volume VB1 and the air volume VB2 may be increased as the temperature difference TBD decreases.

The fan air volume V in each of the third embodiment, the ninth embodiment and the tenth embodiment may be changed. In the battery temperature increase control according to each embodiment, the fan air volume VC1, which is used when the external air introduction mode is selected and the vehicle window state is the open state, is set to the air volume larger than the fan air volume VC2, which is used when the external air introduction mode is selected and the vehicle window state is the closed state. Alternatively, the fan air volume VC1 and the fan air volume VC2 may be set to the same value.

The fan air volume V in each of the third embodiment and the tenth embodiment may be changed. In the battery temperature increase control in each embodiment, the fan air volume VD1, which is used when the internal air circulation mode is selected and the vehicle window state is the open state, is set to the air volume that is larger than the fan air volume VD2, which is used when the internal air circulation mode is selected and the vehicle window state is the closed state. Alternatively, the fan air volume VD1 and the fan air volume VD2 may be set to the same value.

The fan air volume V in each of the third embodiment, the ninth embodiment and the tenth embodiment may be changed. In the battery temperature increase control according to each embodiment, the fan air volume VD1, which is used when the internal air circulation mode is selected and the vehicle window state is the open state, is set to the air volume that is smaller than each of the fan air volume VC1 and the fan air volume VC2, used when the external air introduction mode is selected, and larger than 0. Alternatively, the fan air volume VD1, which is used when the internal air circulation mode is selected and the vehicle window state is the open state, may be set to 0. That is, the air supply to the secondary battery 40 may be stopped when the internal air circulation mode is selected and the vehicle window state is the open state.

The fan air volume V in each of the third embodiment and the tenth embodiment may be changed. In the battery temperature increase control according to each embodiment, the fan air volume VD2, which is used when the internal air circulation mode is selected and the vehicle window state is the closed state, is set to the air volume that is smaller than each of the fan air volume VC1 and the fan air volume VC2, used when the external air introduction mode is selected, and larger than 0. Alternatively, the fan air volume VD2, which is used when the internal air circulation mode is selected and the vehicle window state is the closed state, may be set to 0. That is, the air supply to the secondary battery 40 may be stopped when the internal air circulation mode is selected and the vehicle window state is the closed state.

The fan air volume in each of the third embodiment, the ninth embodiment and the tenth embodiment may be changed. That is, the air volume VC1, the air volume VC2 and the air volume VD1 in each embodiment may be set based on the secondary battery temperature TB, as shown in FIG. 21. That is, the air volume VC1, the air volume VC2 and the air volume VD1 may be increased as the secondary battery temperature TB increases.

The fan air volume V in each of the third embodiment, the ninth embodiment and the tenth embodiment may be changed. The air volume VC1, the air volume VC2 and the air volume VD1 in each embodiment may be changed based on the temperature difference TBD, as shown in FIG. 22. That is, the air volume VC1, the air volume VC2 and the air volume VD1 may be increased as the temperature difference TBD decreases.

The fan air volume V in each of the third embodiment and the ninth embodiment may be changed. The air volume VD2 in each embodiment may be set based on the secondary battery temperature TB, as shown in FIG. 21. That is, the air volume VD2 may be increased as the secondary battery temperature TB increases.

The fan volume V according to each of the third embodiment and the ninth embodiment may be changed. The air volume VD2 in each embodiment may be set based on the temperature difference TBD, as shown in FIG. 22. That is, the air volume VD2 may be increased as the temperature difference TBD decreases.

The fan air volume V according to each of the third embodiment, the ninth embodiment and the tenth embodiment may be changed. In the battery temperature increase control according to each embodiment, the fan air volume VC2, which is used when the external air introduction mode is selected and the vehicle window state is the closed state, is set to the air volume that is larger than the fan air volume VD1, which is selected when the internal air circulation mode is selected and the vehicle window state is the open state. Alternatively, the fan air volume VC2 and the fan air volume VD2 may be set to the same value. Further alternatively, the fan air volume VD1 may be set to the air volume larger than the fan air volume VD2.

In the sixth embodiment, the fan air volume VA1, which is used when the secondary battery temperature TB is equal to or higher than the extremely-low temperature reference value TBZ and the external air introduction mode is selected, is set to the air volume that is larger than the fan air volume VA2, which is used when the secondary battery temperature TB is equal to or higher than the extremely-low temperature reference value TBZ and the internal air circulation mode is selected. Alternatively, the fan air volume V that is used when the secondary battery temperature TB is equal to or higher than the extremely-low temperature reference value TBZ may be set to a constant value regardless of whether the air mode is the internal air circulation mode or the external air introduction mode.

In the seventh embodiment, the fan air volume VB1, which is used when the secondary battery temperature TB is equal to or higher than the extremely-low temperature reference value TBZ and the vehicle window state is the open state, is set to the air volume that is larger than the fan air volume VB2, which is used when the secondary battery temperature TB is equal to or higher than the extremely-low temperature reference value TBZ and the vehicle window state is the closed state. Alternatively, the fan air volume V, which is used when the secondary battery temperature TB is equal to or higher than the extremely-low temperature reference value TBZ, may be set to a constant value regardless of whether the vehicle window state is the open state or the closed state.

The fan air volume V in the eighth embodiment may be changed. In the battery temperature increase control, the fan air volume V, which is used when the secondary battery temperature TB is equal to or higher than the extremely-low temperature reference value TBZ and lower than the low temperature reference value TBX, is set to the fan air volume VA3 that is smaller than the fan air volume VA1 and larger than the fan air volume VA2. Alternatively, the fan air volume V, which is used when the secondary battery temperature TB is equal to or higher than the extremely-low temperature reference value TBZ and lower than the low temperature reference value TBX, may be set to 0. That is, the air supply to the secondary battery 40 may be stopped. Further alternatively, the fan air volume VA3 and the fan air volume VA2 may be set to the same value.

According to each of the sixth to the tenth embodiments, it is determined whether the secondary battery temperature TB is lower than the extremely-low temperature reference value TBZ in the temperature increase air volume control process for the battery temperature increase control. Alternatively, this determination may be made in the basic temperature control process in the battery temperature control. That is, if it is determined that the secondary battery temperature TB is lower than the extremely-low temperature reference value TBZ, the battery temperature increase control and the battery temperature decrease control may be refrained from being executed.

The ninth embodiment and the tenth embodiment may be combined with each other. In this case, if the fan air volume V is set in such a manner that the fan air volume VC2 is smaller than the fan air volume VC1, the fan air volume VD1 is smaller than the fan air volume VC2, and the fan air volume VD2 is smaller than the fan air volume VD1, the effects that are similar to the effects in the ninth and tenth embodiments may be obtained.

The eleventh and the twelfth embodiments may be combined with each other. In this case, the fan air volume V may be increased as the secondary battery temperature TB increases, and the fan air volume V may be increased as the temperature difference TBD decreases.

According to the second embodiment, if it is confirmed that the multiple door windows 12 are all closed, it is determined that the vehicle window state is the closed state, and if it is confirmed that at least one of the door windows 12 is open, it is determined that the vehicle window state is the open state. Alternatively, the manner for determining whether the vehicle window state is the open state or the closed state may be changed to the following manner. If it is confirmed that the opening amount of each of all the door windows 12 is larger than the reference value, it may be determined that the vehicle window state is the open state.

In each embodiment, the invention is applied to the vehicle 10 that is not provided with a humidity sensor that detects the humidity in the vehicle compartment 11 or the humidity outside the vehicle 10. Alternatively, the invention may be applied to a vehicle that is provided with a humidity sensor. In this case, the fan air volume V may be set based on the parameter that indicates the degree of introduction of the external air into the vehicle compartment 11 (at least one of whether the air mode is the internal air circulation mode or the external air introduction mode and whether the vehicle window state is the open state or the closed state) and the humidity detected by the humidity sensor.

What is claimed is:

1. A temperature control apparatus for an in-vehicle electric storage device, which supplies air from a vehicle compartment to the in-vehicle electric storage device based on a temperature of the in-vehicle electric storage device, comprising:
a controller that sets a supply air volume, which is a volume of air that is supplied from the vehicle compartment to the in-vehicle electric storage device, based on a degree of introduction of external air into the vehicle compartment; and
an air blower that supplies the in-vehicle electric storage device with the air in the supply air volume that is set by the controller.

2. The temperature control apparatus according to claim 1, wherein when the supply air volume that is used when an in-vehicle air-conditioner is in an external air introduction mode is a supply air volume A1 and the supply air volume that is used when the in-vehicle air-conditioner is in an internal air circulation mode is a supply air volume A2, the supply air volume A2 is set to a value that is smaller than the supply air volume A1.

3. The temperature control apparatus according to claim 1, wherein when the supply air volume that is used when it is determined that a vehicle window state is an open state is a supply air volume B1 and the supply air volume that is used when it is determined that the vehicle window state is a closed state is a supply air volume B2, the supply air volume B2 is set to a value that is smaller than the supply air volume B1.

4. The temperature control apparatus according to claim 1, wherein when the supply air volume that is used when an in-vehicle air-conditioner is in an external air introduction mode and it is determined that a vehicle window state is an open state is a supply air volume C1 and the supply air volume that is used when the in-vehicle air-conditioner is in the external air introduction mode and it is determined that the vehicle window state is a closed state is a supply air volume C2, the supply air volume C2 is set to a value that is smaller than the supply air volume C1.

5. The temperature control apparatus according to claim 1, wherein when the supply air volume that is used when an in-vehicle air-conditioner is in an internal air circulation mode and it is determined that a vehicle window state is an open state is a supply air volume D1 and the supply air volume that is used when the in-vehicle air-conditioner is in the internal air circulation mode and it is determined that the vehicle window state is a closed state is a supply air volume D2, the supply air volume D2 is set to a value that is smaller than the supply air volume D1.

6. The temperature control apparatus according to claim 1, wherein when the supply air volume that is used when an in-vehicle air-conditioner is in an external air introduction mode and it is determined that a vehicle window state is an open state is a supply air volume C1, the supply air volume that is used when the in-vehicle air-conditioner is in the external air introduction mode and it is determined that the vehicle window state is a closed state is a supply air volume C2, the supply air volume that is used when the in-vehicle air-conditioner is in an internal air circulation mode and it is determined that the vehicle window state is the open state is a supply air volume D1, and the supply air volume that is used when the in-vehicle air-conditioner is in the internal air circulation mode and it is determined that the vehicle window state is the closed state is a supply air volume D2, the supply air volume D2 is set to a value that is smaller than the supply air volume D1, the supply air volume D1 is set to a value that is smaller than the supply air volume C2, and the supply air volume C2 is set to a value that is smaller than the supply air volume C1.

7. The temperature control apparatus according to claim 1, wherein when the temperature of the in-vehicle electric storage device is lower than a normal temperature reference value, which is used to determine whether a charge-discharge performance of the in-vehicle electric storage device is maintained at a charge-discharge performance required to drive a vehicle, the controller sets the supply air volume based on the temperature of the in-vehicle electric storage device.

8. The temperature control apparatus according to claim 7, wherein when the temperature of the in-vehicle electric storage device is lower than the normal temperature reference value, the controller sets the supply air volume to a smaller value as the temperature of the in-vehicle electric storage device decreases.

9. The temperature control apparatus according to claim 1, wherein when the temperature of the in-vehicle electric storage device is lower than a normal temperature reference value, which is used to determine whether a charge-discharge performance of the in-vehicle electric storage device is maintained at a charge-discharge performance required to drive a vehicle, the controller sets the supply air volume based on a difference between the temperature of the in-vehicle electric storage device and a temperature in the vehicle compartment.

10. The temperature control apparatus according to claim 9, wherein when the temperature of the in-vehicle electric storage device is lower than the normal temperature reference value and the temperature in the vehicle compartment is higher than the temperature of the in-vehicle electric storage device, the controller sets the supply air volume to a smaller value as the difference between the temperature of the in-vehicle electric storage device and the temperature in the vehicle compartment increases.

11. The temperature control apparatus according to claim 9, wherein when the temperature in the vehicle compartment is higher than the temperature of the in-vehicle electric storage device and the difference between the temperature of the in-vehicle electric storage device and the temperature in the vehicle compartment is larger than a reference temperature difference, the air blower refrains from supplying the air from the vehicle compartment to the in-vehicle electric storage device.

12. The temperature control apparatus according to claim 1, wherein when the temperature of the in-vehicle electric storage device is equal to or higher than a normal temperature reference value, which is used to determine whether a charge-discharge performance of the in-vehicle electric storage device is maintained at a charge-discharge performance required to drive a vehicle, the air blower refrains from supplying the air from the vehicle compartment to the in-vehicle electric storage device.

13. The temperature control apparatus according to claim 12, wherein when the temperature of the in-vehicle electric storage device is equal to or higher than a high temperature reference value that is higher than the normal temperature reference value, the air blower supplies the air from the vehicle compartment to the in-vehicle electric device.

14. The temperature control apparatus according to claim 1, wherein when the temperature of the in-vehicle electric storage device is lower than an extremely-low temperature reference value that is lower than a normal temperature reference value, which is used to determine whether a charge-discharge performance of the in-vehicle electric storage device is maintained at a charge-discharge performance required to drive a vehicle, the air blower refrains from supplying the air from the vehicle compartment to the in-vehicle electric storage device.

15. The temperature control apparatus according to claim 14, wherein when the temperature of the in-vehicle electric storage device is lower than a low temperature reference value that is lower than the normal temperature reference value and higher than the extremely-low temperature reference value and an in-vehicle air-conditioner is in an internal air circulation mode, the air blower refrains from supplying the air from the vehicle compartment to the in-vehicle electric storage device.

16. The temperature control apparatus according to claim 14, wherein when the temperature of the in-vehicle electric storage device is lower than a low temperature reference value that is lower than the normal temperature reference value and higher than the extremely-low temperature reference value and it is determined that a vehicle window state is a closed state, the air blower refrains from supplying the air from the vehicle compartment to the in-vehicle electric storage device.

17. The temperature control apparatus according to claim 1, wherein when an in-vehicle air-conditioner is in an internal air circulation mode, the air blower refrains from supplying the air from the vehicle compartment to the in-vehicle electric storage device.

18. The temperature control apparatus according to claim 17, wherein when the in-vehicle air-conditioner is in the internal air circulation mode and it is determined that a vehicle window state is an open state, the air blower supplies the air from the vehicle compartment to the in-vehicle electric storage device.

19. The temperature control apparatus according to claim 1, wherein when it is determined that a vehicle window state is a closed state, the air blower refrains from supplying the air from the vehicle compartment to the in-vehicle electric storage device.

20. The temperature control apparatus according to claim 19, wherein when it is determined that the vehicle window state is the closed state and an in-vehicle air-conditioner is in an external air introduction mode, the air blower supplies the air from the vehicle compartment to the in-vehicle electric storage device.

21. A temperature control apparatus for an in-vehicle electric storage device, which supplies air from a vehicle compartment to the in-vehicle electric storage device based on a temperature of the in-vehicle electric storage device, comprising:
a controller that sets a supply air volume, which is a volume of air that is supplied from the vehicle compartment to the in-vehicle electric storage device, to a smaller value as the temperature of the in-vehicle electric storage device decreases, when the temperature of the in-vehicle electric storage device is lower than a normal temperature reference value, which is used to determine whether a charge-discharge performance of the in-vehicle electric storage device is maintained at a charge-discharge performance required to drive a vehicle; and
an air blower that supplies the in-vehicle electric storage device with the air in the supply air volume that is set by the controller.

22. A temperature control apparatus for an in-vehicle electric storage device, which supplies air from a vehicle compartment to the in-vehicle electric storage device based on a temperature of the in-vehicle electric storage device, comprising:
a controller that sets a supply air volume, which is a volume of air that is supplied from the vehicle compartment to the in-vehicle electric storage device, to a smaller value as a difference between the temperature of the in-vehicle electric storage device and a temperature in the vehicle compartment increases, when the difference is smaller than a reference temperature difference, which is used to determine whether there is a high possibility that an air supply from the vehicle compartment to the in-vehicle electric storage device causes condensation in the in-vehicle electric storage device; and
an air blower that supplies the in-vehicle electric storage device with the air in the supply air volume that is set by the controller.
